(19) United States
(12) Patent Application Publication
(10) Pub. No.: US 2026/0115925 A1
(43) Pub. Date: Apr. 30, 2026

(54) SCHEME FOR MULTIMODAL ROBOTIC TELEOPERATION AND TELEPRESENCE

(71) Applicant: Crazing Lab, Inc., Sunnyvale, CA (US)

(72) Inventors: Sang-Pyo Kim, Los Altos, CA (US); Jaeyoung Lee, Seongnam-si (KR)

(21) Appl. No.: 19/311,668

(22) Filed: Aug. 27, 2025

Related U.S. Application Data
(60) Provisional application No. 63/711,686, filed on Oct. 24, 2024.

(51) Int. Cl. B25J 9/16

(52) U.S. Cl. CPC B25J 9/1689; B25J 9/162; B25J 9/163; B25J 9/1664

(57) ABSTRACT

Embodiments relate to operating a robot from a remote location in multiple modes including an online mode, a trained mode, a delegation mode and an autonomous navigation mode. By enabling the control of the robot using various modes, the robot may be controlled more conveniently and efficiently while attaining accuracy of its operation when desired. Embodiments also relate to capturing a user interface of a machine and presenting the captured user interface to a user via a client device to enable the user to control the machine using the client device. Commands received from the client device emulate user actions on the machine's user interface to operate the machine. In this way, desired operations on the machine may be performed by the user in a convenient manner without using complicated schemes to provide interoperability between different machines and controllers.

### CROSS-REFERENCE TO RELATED APPLICATIONS

This application claims priority under 35 U.S.C. § 119(e) to U.S. patent application Ser. No. 63/711,686, filed on Oct. 25, 2024, which is incorporated by reference herein in its entirety.

### BACKGROUND

The present disclosure relates to teleoperating or telepresence using robots, more specifically, to enabling teleoperating or telepresence using robots operable in multiple modes.

Robots are frequently managed and controlled from a distance by human operators to execute a wide range of tasks. Such remote manipulation, known as teleoperation, grants operators the ability to control robots remotely. Teleoperation enables the operators to undertake assignments in locations that are otherwise difficult to reach, inefficient for human presence, or perilous. In parallel, the concept of telepresence via robotic technology offers a distinct yet complementary advantage. Telepresence provides immersive experiences that effectively simulate the sensation of the operators'physical presence in a remote environment. This immersive capability of telepresence finds its utility in several sectors including education, business and entertainment.

Collectively, teleoperation and telepresence work in tandem, significantly expanding the scope and effectiveness of remote interactions using robots. Telepresence not only complements the functional control provided by teleoperation but also adds a layer of experiential realism, making remote operations feel more natural and intuitive.

The teleoperation and telepresence associated with controlling multiple machines pose challenges due to the inherent complexity of integrating diverse systems and technologies. One of the obstacles is the incompatibility between machine controllers, middleware, and user devices. Machine controllers often use proprietary protocols and communication standards, making it difficult to establish seamless connections with external systems. Middleware, which acts as an intermediary layer, must be capable of translating and bridging these disparate protocols, adding another layer of complexity. Furthermore, user devices may have varying operating systems, hardware capabilities, and network constraints, further complicating the remote control process. Such technological fragmentation make it difficult to effectively control robots across different platforms and user devices.

### SUMMARY

Embodiments described herein relate to teleoperating a robot. In an online mode, manual operating commands are received from a client device in a streaming manner, and the received manual operating commands are sent to the robot. The robots are placed in an autonomous navigation mode in which the robot autonomously navigates from its current location to a destination when a mode switch command is received from the client device. In the autonomous navigation mode, the client device receives options for selecting the destination to be presented on the client device using a map or identifiers. Selection of the destination is received from the client device, which causes the robot to autonomously navigate from the current location to the selected destination.

In one or more embodiments, the map includes a two-dimensional (2D) floorplan or a 2D map. The destination is one of the predesignated locations on the map, and the identifiers are mapped to one of the predesignated locations.

In one or more embodiments, the mapping of the identifiers to the predesignated locations is sent to the client device for presentation on the client device.

In one or more embodiments, switching to a simulation mode is performed when a mode switch command is received from the client device. In the simulation mode, the client device displays a simulated environment corresponding to a real environment of the robot. Simulation commands are received from the client device to perform a task using the robot, and interaction between a virtual version of the robot and one or more virtual objects in the simulated environment that corresponds to one or more real objects in the real environment is simulated to generate a simulated result. The simulated result is sent to the client device to display the interaction between the robot and one or more virtual objects.

In one or more embodiments, a virtual version of a part of the robot or a virtual version of another object occluding the one or more virtual objects is removed from display at the client device.

In one or more embodiments, a machine learning model or recording corresponding to the task and derived from the simulation commands is generated in the simulation mode. The machine learning model or the recording is sent to the robot for deployment.

In one or more embodiments, switching to a trained mode is performed when a mode switch command is received from the client device. In the trained mode, a task command to perform the task by the robot is received from the client device. In response to receiving the task command, the robot loads and executes a corresponding machine learning model or recording.

In one or more embodiments, switching to a delegation mode is performed when a mode switch command is received from the client device. In the delegation mode, a delegation command is received from the client device indicating the delegation of control of at least part of the robot to another person. When a computing device receives delegated commands from the delegated person, the delegated commands are sent to the robot for its control.

In one or more embodiments, options for selecting the other person to be delegated are sent to the client device for presenting on the client device of an operator.

In one or more embodiments, a transition command is received from the client device to transition control of the robot to another robot when choices of robots available for transitioning are sent to the client device. Operating commands received from the client device are sent to the other robot and information received from the other robot is forwarded to the client device after the transition command is received.

In one or more embodiments, graphical user interface elements corresponding to locations available for selection as a destination of the robot using a map or identifiers of the locations are displayed by a client device. The destination among the available locations is selected using one of the graphical user interface elements. By selecting the destination, the robot is instructed to autonomously navigate to the destination.

In one or more embodiments, the map includes a two-dimensional (2D) floorplan or a 2D map. The destination is one of the predesignated locations on the map, and the identifiers are mapped to one of the predesignated locations.

In one or more embodiments, mapping of the identifiers to the predesignated locations is received from a computing device located remotely from the client device.

In one or more embodiments, a graphical user interface element selectable to switch to a simulation mode is displayed. A mode switch command is sent to a computing device after the displayed graphical user interface element is selected on the client device. Information on the simulated environment corresponding to the real environment of the robot is received after sending the mode switch command. The simulated environment is displayed on the client device and simulation commands are sent to the computing device to perform simulation of a task using the robot. A simulated result is generated by simulating interaction between a virtual version of the robot and one or more virtual objects in the simulated environment that corresponds to one or more real objects in the real environment.

In one or more embodiments, the simulated environment is displayed in one or more of virtual reality (VR), mixed reality (MR) or augmented reality (AR).

In one or more embodiments, a graphical user interface element selectable to switch to a trained mode is displayed. A mode switch command is sent to the computing device to cause the robot to switch to the trained mode after receiving the selection of the displayed graphical user interface element. A task command is sent to perform a trained task by the robot to cause the robot to load and execute a machine learning model or a recording associated with the trained task.

In one or more embodiments, a delegation command is sent to a computing device communicating with the robot responsive to selection of a graphical user interface element corresponding to the delegation command. The delegation command indicates delegation of control of at least part of the robot from an operator to another person.

In one or more embodiments, graphical user interface elements are displayed for selecting the other person to be delegated to control the robot.

In one or more embodiments, at least part of the manual operating commands in the online mode are sent to another robot by the robot to control the other robot.

In one or more embodiments, a sensor signal from the other robot is received via the robot.

Embodiments also relate to managing a facility remotely by capturing a user interface of a machine in the facility and controlling the machine by emulating user actions on the user interface. Captured versions of images representing the user interface for operating the machine are received. The captured versions of the images to a client device to cause the client device to display the captured versions of the images on the client device. A command is received from the client device after sending the captured versions of the images to the client device. The command indicates manipulation of one or more graphical user elements in the user interface. The command is sent to the machine to cause the machine to emulate a user action corresponding to the command on the one or more graphical user elements.

In one or more embodiments, images of a scene including the machine from a camera are received. The images of the scene are sent to the client device to cause the client device to display the images of the scene.

In one or more embodiments, selection of the machine is received from the client device. The captured versions of images are sent to the client device after receiving the selection of the machine.

In one or more embodiments, a machine learning model is trained using the command or the command is recorded for a subsequent operation of the machine.

### BRIEF DESCRIPTION OF DRAWINGS

FIG. 1 is an architectural diagram of a robotic system, according to one embodiment.

FIG. 2A is a schematic diagram of a robot according to one embodiment.

FIG. 2B is a block diagram of an onboard computing device of the robot, according to one embodiment.

FIG. 2C is a block diagram of software components in the robot, according to one embodiment.

FIG. 3A is a block diagram of a control server communicating with the robot, according to one embodiment.

FIG. 3B is a block diagram of software components in the control server, according to one embodiment.

FIG. 4A is a client device used by an operator to operate the robot, according to one embodiment.

FIG. 4B is a block diagram of the client device of FIG. 4A, according to one embodiment.

FIG. 4C is a block diagram of software components in the client device of FIG. 4A, according to one embodiment.

FIG. 5A is an example environment map of premises, according to one embodiment.

FIG. 5B is an example destination mapper, according to one embodiment.

FIGS. 6A through 6C are graphical user interface diagrams for operating the robot, according to embodiments.

FIGS. 7A and 7B are graphical user interface diagrams for operating actuators of the robot, according to embodiments.

FIG. 8 is a graphical user interface diagram for activating a delegation mode of the robot, according to one embodiment.

FIG. 9 is a graphical user interface diagram for switching a robot being controlled, according to one embodiment.

FIGS. 10A and 10B are graphical user interface diagrams for choosing and executing trained tasks by the robot, according to embodiments.

FIG. 11 is a flowchart illustrating the process of operating the robot in multiple modes, according to one embodiment.

FIG. 12A is a conceptual diagram illustrating the robot of FIG. 2A controlling another robot, according to one embodiment.

FIG. 12B is a graphical user interface diagram for operating the other robot of FIG. 12B, according to one embodiment.

FIG. 13 is a diagram illustrating a robot capturing a scene including a machine, according to one embodiment.

FIG. 14A is a block diagram of a controller in the machine of FIG. 13, according to one embodiment.

FIG. 14B is a block diagram of software components in the controller, according to one embodiment.

FIG. 15 is an interaction diagram illustrating interactions between a machine, a robot, a control server and a client device, according to one embodiment.

FIG. 16A is a graphical user interface diagram showing scenes captured by cameras, according to one embodiment.

FIGS. 16B and 16C are user interface diagrams of machines, according to one embodiment.

FIGS. 16D and 16E are user interface diagrams showing user interfaces of selected machines, according to one embodiment.

The figures depict embodiments of the present disclosure for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments relate to operating a robot from a remote location in multiple modes including an online mode, a simulation mode, a trained mode, a delegation mode and an autonomous navigation mode. In the online mode, an operator controls the operation of the robot directly via a network. In the simulation mode, interactions of the robot and its environment are simulated to generate machine learning models or recordings of operations for tasks to be performed on the robot. In the trained mode, trained machine learning models or recordings are used to control the robot for the trained tasks. In the delegation mode, the operator delegates the control of the robot to another person. In the autonomous navigation mode, the robot automatically navigates around the premises to reach a destination as designated by the operator. By enabling the control of the robot using various modes, the operator may control the robot more conveniently and efficiently to accomplish tasks while attaining accuracy of operations as desired.

Embodiments also relate to capturing a user interface of a machine and presenting the captured user interface to a user via a client device to enable the user to control the machine using the client device. A controller of the machine may be installed with a module that captures the machine's user interface and forwards commands received from the client device to the machine's user interface to operate the machine. Scenes including the machine may be captured by a camera and be presented to the user via the client device to facilitate the user's operation of the machine using the client device. In this way, desired operations on the machine may be performed by the user in a convenient manner without using complicated schemes to provide interoperability between different machines and controllers.

### Example Architecture of Robotic System

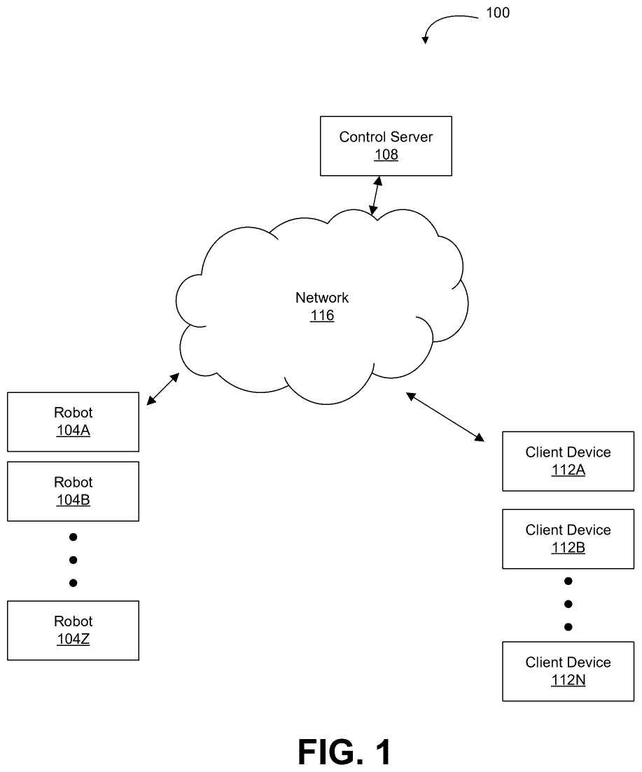

FIG. 1 is an architectural diagram of a robotic system 100, according to one embodiment. Robotic system 100 may include, among other components, robots 104A through 104Z (hereinafter referred to individually as “robot 104” or collectively as “robots 104”), client devices 112A through 112N (hereinafter referred to individually as “client device 112” or collectively as “client devices 112”), a network 116 and a control server 108. Robotic system 100 may include components not illustrated in FIG. 1 such as premises devices (e.g., equipment, machines, and sensors) deployed on premises where the robots 104 operate and communicate via network 116.

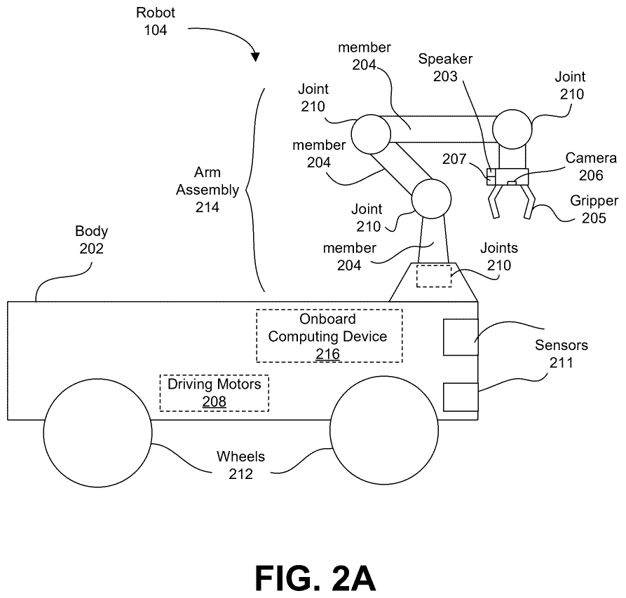

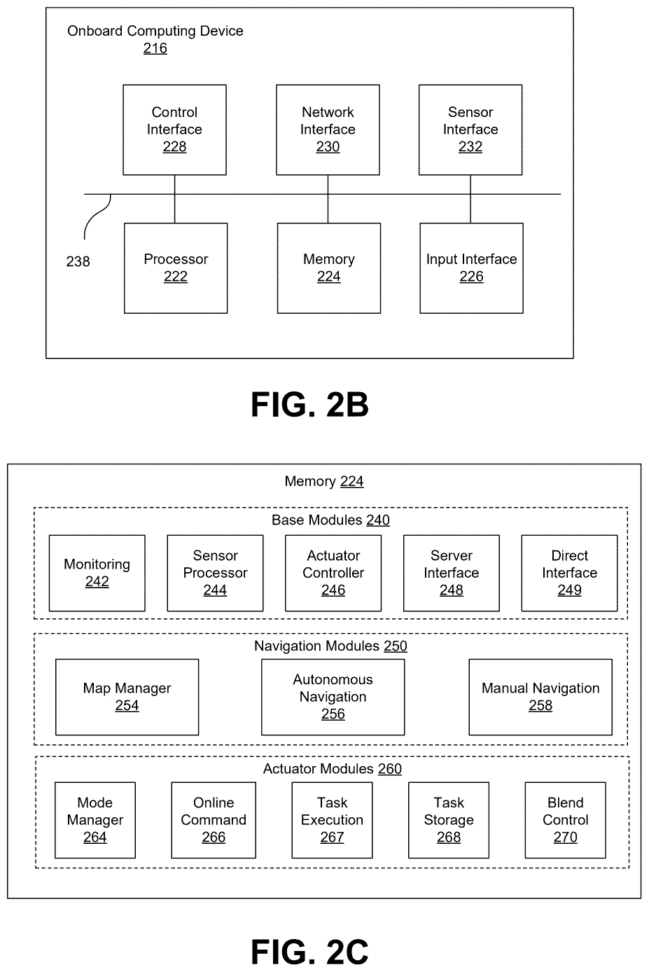

Robots 104 are machines that are capable of performing physical operations and/or sensing of environment where they operate. One or more of these robots 104 may operate on the same premises or at least a subset of the robots may be deployed in various locations. Further, robots 104 may be of similar configurations or have different configurations to perform distinct functions. Depending on their configurations, some robots may only be operated in some of the modes while other robots are capable of being operated in all of the modes. An example robot is described below in detail with references to FIGS. 2A through 2C. An operator may be authorized to operate all of the robots 104. Alternatively, an operator may be authorized to operate only a subset of robots 104 while other operators are authorized to operate different subsets of robots 104. Although robots 104 may all operate in the same premises in some scenarios, each of robots 104 operates in different premises or locations in most scenarios.

Robots 104 may be operated in various types of premises and be used in various applications. One category of applications is industrial application where robots 104 are used in factories or facilities to perform or assist operations. Another category of applications is telepresence where the operator attends events or meets other people using the robot. Combined with mixed reality (MR), augmented reality (AR) and virtual reality (VR) technology, the operator may experience the robot's environment in an immersive manner using client device 112. In the applications of telepresence, robots 104 may be used in various environments including healthcare facilities, factories, offices, homes, showrooms, and event venues (e.g., stadium or concert halls).

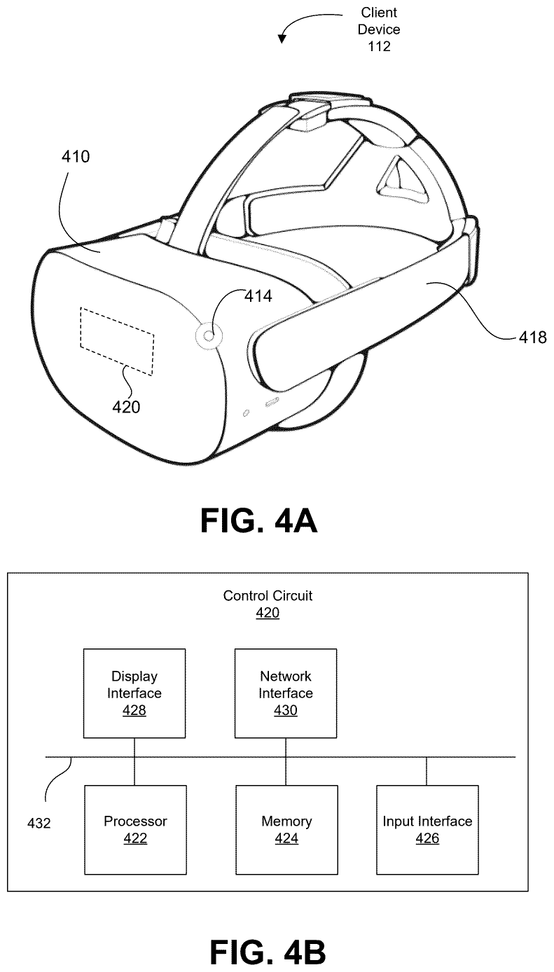

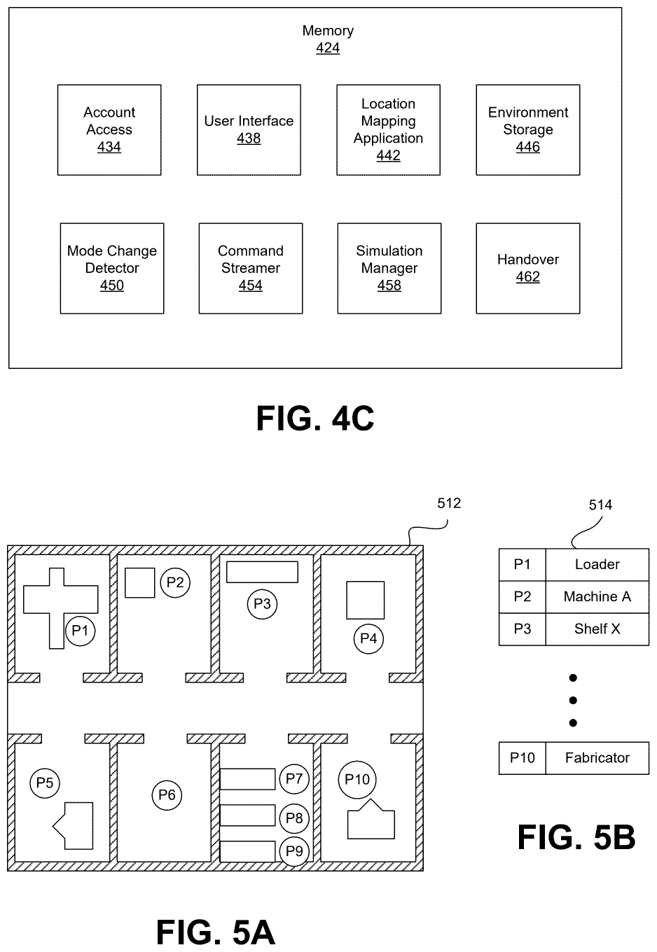

Client device 112 is a computing device used by the operator to select a mode of robot 104 and control robot 104. Different operators may use different types of client devices to make the selection of modes and operate robots. Client device 112 has networking capabilities to communicate with robots 104 directly or via control server 108. Client device 112 may be embodied as a head mount display device, a desktop computer, a laptop computer, a cellular phone, a smartphone, a game console, a set-top box, a personal digital assistant (PDA), or IoT devices, among other things. An example client device 112 is described below in detail with reference to FIGS. 4A through 4C.

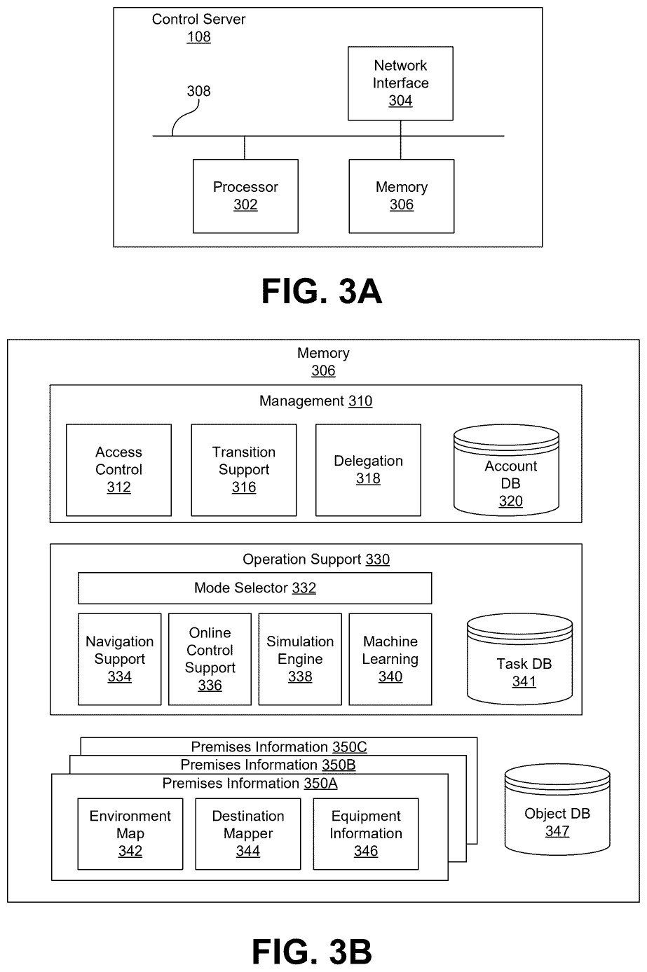

Control server 108 is a computing device that mediates the operations of robots 104 and supports the multimodal operations of robots 104. Control server 108 performs various operations, including but not limited to, manage accounts of operators, control access to the robots, generate simulated environment of the robots, support autonomous navigation of the robots, perform handover operations to switch between different robots or modes, and generate machine learning models or recordings of operations for deployment on the robots. Although only a single control server 108 is illustrated in FIG. 1, a collection of control servers may interoperate to provide these functions. Example control server 108 is described below in detail with reference to FIGS. 3A and 3B. In some embodiments, client devices 112 may directly control robots 104 without the intervention of control server 108.

Network 116 is a collection of network devices that communicate and route network packets from a source computing device to one or more destination computing devices, and may be embodied as, among others, Local Area Networks (LANs), Wide Area Networks (WANs), Wireless Local Area Networks (WLANs), Metropolitan Area Networks (MANs), Campus Area Networks (CANs), Storage Area Networks (SANs), Virtual Private Networks (VPNs), Intranets, Extranets, the Internet, Peer-to-Peer Networks, Mobile Networks and a combination thereof. These networks may be implemented using one or more communication technologies such as Ethernet, Universal Serial Bus (USB), Wi-Fi, Bluetooth, Zigbee, Z-Wave, Global System for Mobile Communications (GSM), Code Division Multiple Access (CDMA), Long-Term Evolution (LTE), Second Generation (2G), Third Generation (3G), Fourth Generation (4G), Fifth Generation (5G), and Sixth Generation (6G).

### Architecture of Example Robot

FIG. 2A is a schematic diagram of robot 104 according to one embodiment. Robot 104 may include, among other components, a body 202 as a platform, wheels 212, and an arm assembly 214 mounted onto body 202. Body 202 may include sensors 211, driving motors 208 for operating wheels 212, and onboard computing device 216. Body 202 may further include a steering mechanism for changing the moving direction of robot 104. Such steering mechanism and driving motors 208 are operated by control signals from onboard computing device 216 to navigate around the premises in which robot 104 is located. Robot 104 may include components other than what are illustrated in FIG. 2A such as additional arm assemblies, display devices, and a power source.

Arm assembly 214 or other actuating mechanisms mounted to body 202 may be used to interact with other objects in the environment. Arm assembly 214 may include joints 210, motors (not shown) for operating joints 210, members 204 between joints 210, speaker 203, gripper 205, camera 206 and microphone 207. The motors, gripper 205 and camera 206 may be operated by onboard computing device 216 to perform various operations such as grabbing or releasing objects. Camera 206 may capture images of objects being manipulated by gripper 205. Camera 206 may be located at different parts of arm assembly 214 or additional cameras may be provided on arm assembly 214 to assist the operation of arm assembly 214. Speaker 203 and microphone 207 are provided in arm assembly 214 to enable the operator to interact with another person on the premises via audio communication. Speaker 203 may receive its audio signals from onboard computing device 216 and microphone 207 may send sound signals it detects to onboard computing device 216. Various effectors other than gripper 205 may be provided at the end of arm assembly 214 or elsewhere of arm assembly 214 to perform desired operations. Arm assembly 214 may be offset from the center of body 202 towards a side (e.g., front side, left side, rear side or right side) so that arm assembly 214 may perform various operations on a target object without the interference of body 202.

Robot 104 includes components for supporting online or autonomous navigation. Such components include onboard computing device 216, driving motors 208 and sensors 211. Sensors 211 may include one or more of: cameras, Light Detection and Ranging (Lidar), and proximity sensors. Sensor signals generated by sensors 211 are fed to onboard computing device 216 that performs algorithms such as image processing, object detection and simultaneous localization and mapping (SLAM) to perform online or autonomous navigation.

Robots may be in forms other than what is illustrated in FIG. 2A. For example, robot 104 may include caterpillar tracks as its moving mechanism or the robot may not include any moving mechanism and may remain stationary at a fixed location on the premises. The robot may also include other types of manipulators and/or effectors suitable to perform various other operations, and may take various physical forms such as a humanoid shape.

FIG. 2B is a block diagram of an onboard computing device 216, according to one embodiment. Onboard computing device 216 may include, among other components, processor 222, memory 224, input interface 226, control interface 228, network interface 230, sensor interface 232 and bus 238 connecting these components. Onboard computing device 216 may include other components such as cable interfaces and user interface components such as a display and a keyboard.

Processor 222 retrieves and executes commands stored in memory 224. Processor 222 may be embodied as a central processing unit (CPU), a graphics processing unit (GPU) or application-specific integrated circuits (ASICs). Although only a single processor 222 is illustrated in FIG. 2B, multiple processors may be provided in onboard computing device 216.

Memory 224 stores software components for execution by processor 222 to operate robot 104 and/or to interoperate with client devices 112 and control server 108. Memory 224 may be embodied using various technologies or their combinations, including, for example, Random Access Memory (RAM), Read-Only Memory (ROM), flash memory, Hard Disk Drive (HDD), Solid-State Drive (SSD), virtual memory, magnetic tape and optical discs. Various software components stored in memory 224 are described below in detail with reference to FIG. 2C.

Input interface 226 is hardware or hardware in combination with software that receives data from external sources. The external sources may include user interface devices such as a pointing device and keyboard.

Control interface 228 is hardware or hardware in combination with software that controls actuators such as motors and gripper of robot 104. For this purpose, control interface 228 receives instructions from processor 222, generates control signals, and sends the control signals to the actuators. Control interface 228 may also receive feedback signals from the actuators to perform more accurate operation of actuators.

Network interface 230 enables onboard computing device 216 to receive incoming network packets from network 116 and send outgoing network packets to network 116. Network interface 230 may be embodied as a network interface card (NIC) or a network adaptor, and implement various network protocols and standards. Network interface 230 may also communicate with equipment or other robots within a range from robot 104 to control or interact with the equipment or these other robots.

Sensor interface 232 is hardware or hardware in combination with software that interfaces with sensors 211. Sensors 211 may detect various physical properties for navigating robot 104, supporting operations of arm assembly 214 or operate other robots or equipment. Sensor interface 232 sends control signals to control the operation of sensors and also receives sensor signals from sensors 211 for further processing by processor 222.

FIG. 2C is a block diagram of software components in memory 224 of robot 104, according to one embodiment. Memory 224 may store, among other software components, base modules 240, navigation modules 250 and actuator modules 260. Memory 224 may store further software components (e.g., operation system) or combine multiple software components into a single module.

Base modules 240 described herein refer to software modules that are associated with basic hardware components of robot 104. Base modules 240 may include, among other software modules, monitoring module 242, sensor processor 244, actuator controller 246, server interface 248 and direct interface 249. Monitoring module 242 is a software module that initializes, monitors and takes remedial actions on components of robot 104. Monitoring module 242 senses states of hardware and software components, detects a failure or abnormal states of these components, and takes remedial actions such as resetting these components or alerting the operator of the sensed errors when faults are detected in the hardware components.

Sensor processor 244 performs various algorithms and routines associated with sensor interface 232, including buffering of sensor signals, filtering of noise in sensor signals, converting sensor signals for processing, and converting instructions from navigation modules 250 and/or actuator modules 260 to operate sensors 211 in an adequate manner. Sensor processor 244 may also perform object recognition, for example, by applying filters or machine learning models to image signals. Information on recognizable objects may be received from control server 108 (e.g., object database 347) or client device 112. The sensor processor 244 may cache such information on objects for faster processing.

Actuator controller 246 is software, firmware, hardware or their combinations for generating and sending control signals to actuators in robot 104 in response to receiving commands to operate the actuators from other modules in robot 104. Actuator controller 246 may convert the received commands to lower-level signals that are sent to actuators in robot 104 to perform operations. Actuator controller 246 may be embodied, for example, as a Proportional-Integral-Derivative (PID) controller that continuously monitors the difference between a desired target state of an actuator and a measured state of the actuator, and applies a correction to reduce such difference. Other types of controllers such as fuzzy logic control, model predictive controller (MPC) or state space controller may also be used as actuator controller 246. The commands to actuator controller 246 may be received from online command module 266, task execution module 267 or blend control module 270.

Server interface 248 is a software component that communicates with control server 108 via packet communication. Server interface 248 may receive network packets from control server 108 via network 116, perform error corrections on the network packets, and extract data from the network packets. The extracted data may include, among others, commands, information on objects, and premises information.

Direct interface 249 is a software component that communicates directly with client device 112. In one or more modes, robot 104 may be controlled directly by client device 112 without using control server 108. For example, if client device 112 and robot 104 are within the same premises, client device 112 may bypass control server 108 and connect directly to robot 104. Direct interface 249 implements a wired or wireless communication protocol that enables direct communication with client device 112.

Navigation modules 250 are software components associated with the robot's navigation operations on the premises where it operates. Navigation modules 250 may include map manager module 254, autonomous navigation module 256, and manual navigation module 258. Map manager module 254 stores the environment map of the premises, determines the position of robot 104 in the premises and updates the map according to objects detected by sensors 211. For this purpose, map manager module 254 may perform SLAM algorithm. Map manager module 254 may also receive an updated environment map of the premises from control server 108 and/or send updates to the environment to control server 108 so that the environment map stored in control server 108 is updated. Map manager module 254 may also store destination mapper indicating mapping between locations in the premises and identifiers. An example environment map and an example destination mapper are described below in detail with reference to FIGS. 5A and 5B.

Autonomous navigation module 256 performs autonomous navigation of robot 104 when robot 104 is in the autonomous navigation mode. In this mode, robot 104 autonomously navigates from its current location to a destination by performing path planning and then performing the navigation operation based on the planned path. In one embodiment, onboard computing device 216 performs all of these operations. In other embodiments, onboard computing device 216 sends relevant information to control server 108 to perform at least part of these operation for autonomously navigating on control server 108.

Manual navigation module 258 enables the operator to manually operate robot 104 to navigate robot 104 to a destination. For this purpose, manual navigation module 258 receives streaming online commands from client device 112 via network 116, generates control signals corresponding to the streamed online commands, and sends the generated control signals to driving motors 208 and the steering mechanism. The streamed commands may be received from the operator in a manual operating mode or from a person delegated by the operator in a delegation mode.

Actuator modules 260 described herein refer to software components associated with operating actuators of robot 104. The operated actuators may be part of arm assembly 214 or other manipulators mounted on body 202. Actuator modules 260 may include, for example mode manager module 264, online command module 266, task execution module 267, task storage 268 and blend control module 270. Actuator modules 260 may include other modules not illustrated in FIG. 2C. Actuator modules 260 also sends commands to equipment or other robots, for example, in an online mode or a simulated mode to control the equipment or these other robots via wired or wireless communication.

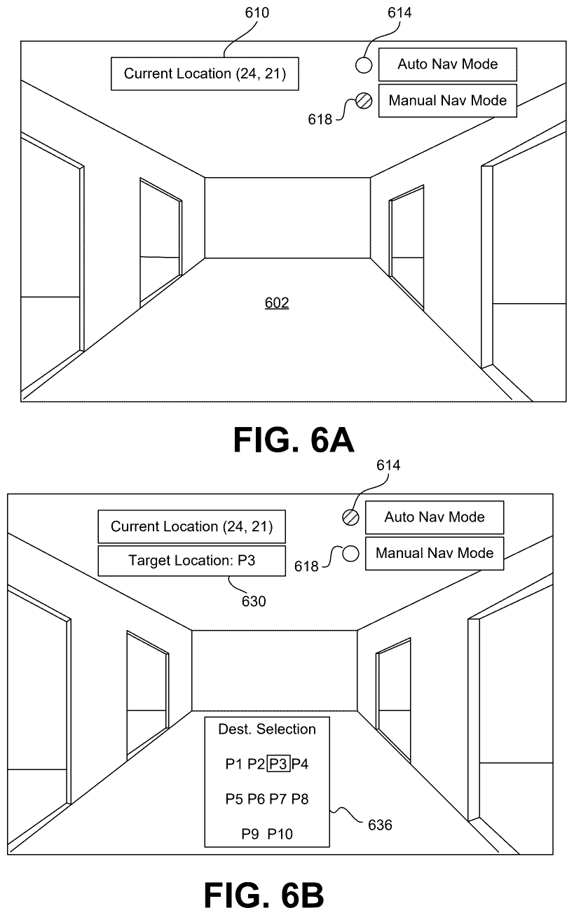

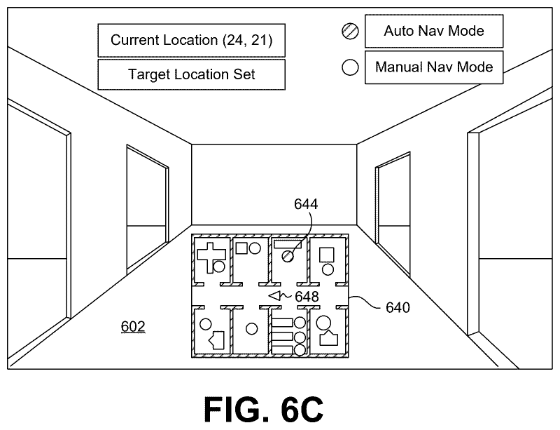

Mode manager module 264 is a software component for activating a mode or switching between modes of operating the actuators in robot 104. Robot 104 may operate in multiple modes including an online mode where robot 104 is operated manually by receiving streaming online commands from client device 112 or in a trained mode where robot 104 is operated by a recorded sequence of commands or a trained machine learning model. The switching of modes by mode manager module 264 may be performed in response to receiving a mode selection command from client device 112 or upon occurrence of certain events (e.g., termination of a trained task by robot 104). The details of the selected modes and operations according to the selected modes are described below in detail with reference to FIGS. 6A through 10B.

Online command module 266 is a software component for supporting the operations of robot 104 in an online mode where robot 104 is operated according to streaming operation commands received from client device 112. The streaming online commands may be received from an operator or a person delegated by the operator to control robot 104. The streaming operation commands indicate the taking of certain actions on robot 104 (e.g., rotate the upper arm of arm assembly 214 by 30 degrees). Online command module 266 converts the streaming operation commands to control signals and sends the operation signals to actuator controller 246 to operate actuators in robot 104 (e.g., arm assembly 214).

Task execution module 267 is a software component that reads one or more tasks from task storage 268 and automatically generates operation commands to operate actuators in robot 104. The commands may be generated sequentially and/or conditionally, and sent to actuator controller 246 so that the actuators are operated to perform the one or more tasks. In some embodiments, task execution module 267 may load machine learning models or the recorded versions of the operations from task storage 268 according to instructions from client device 112 and/or meeting certain conditions (e.g., detection of an object), and execute the loaded machine learning models or the recorded versions of the operations. Task execution module 267 may be disabled during the streaming operation mode.

Task storage 268 stores tasks to be performed by robot 104 when invoked by the operator. The tasks in task storage 268 include ones that are performed using machine learning models (e.g., deep neural network) and others that are recorded versions of the operator's operations. When machine learning models are used, sensor signals from sensor processor 244 or information derived from the sensor signals are fed to the machine learning models, which in turn generate operation commands to actuator controller 246 to perform corresponding tasks by operating actuators in robot 104. Task storage 268 may also store recorded tasks where each task is a sequence of operations of actuators. Such recorded tasks may be generated by recording the operator's commands received by robot 104, and may be simpler tasks that do not involve machine learning models. When using a recorded model, a human operator may remotely control robot 104, another robot or equipment using sensors and communication capabilities of robot 104. For this purpose, the operator may access controlling parameters such as actuator positioning signals, torque control signals, temperature control signals, pressure control signals, and sequence signals. After sequence of actions is established, the sequence may be recorded and executed autonomously by robot 104, the other robot or equipment.

The training of the machine learning models or recording of the commands is performed by onboard computing device 216, control server 108, or client device 112 or any combination thereof. The machine learning models and the recorded tasks in task storage 268 may be a subset or cached version of models and tasks stored in control server 108.

The use of task execution module 267 in combination with task storage 268 advantageously enables: (i) robot 104 to perform time-sensitive tasks or tasks that involve a fine control of the actuators, despite the presence of lag or delay in communication to robot 104, (ii) convenient repetitions of tasks using robot 104 while reducing or eliminating the operator's manual operations.

Blend control module 270 receives outputs from online command module 266 and task execution module 267, blends these outputs, and generates blended commands for sending to actuator controller 246 in a blended control mode. In this mode, a task is largely automated but still allows the operator to fine-tune the control of the actuators. In some operations, a subset of actuators is controlled by online command module 266 while the remaining actuators are controlled by outputs from task execution module 267.

### Architecture of Example Control Server

Control server 108 is a computing device that performs various operations to support and facilitate multiple operators to operate their robots. In one or more embodiments, control server 108 is embodied as a server in cloud computing environment. Although the following describes control server 108 as being a single computing device to simply explanation, in practice, control server 108 may be a collection of computing devices that performs operations in a distributed manner.

FIG. 3A is a block diagram of control server 108, according to one embodiment. Control server 108 may include, among other components, processor 302, network interface 304, memory 306, and bus 308 connecting these components. Control server 108 may include other components such as an input/output (IO) interface.

Processor 302 retrieves and executes commands stored in memory 306. Processor 302 may be embodied as a central processing unit (CPU), a graphics processing unit (GPU) or application-specific integrated circuits (ASICs). Although only a single processor 302 is illustrated in FIG. 2B, multiple processors may be provided in control server 108.

Memory 306 stores software components for execution by processor 302. Memory 306 may be embodied using various technologies or their combinations, including, for example, Random Access Memory (RAM), Read-Only Memory (ROM), flash memory, Hard Disk Drive (HDD), Solid-State Drive (SSD), virtual memory, magnetic tape and optical discs. Various software components stored in memory 306 are described below in detail with reference to FIG. 3B.

Network interface 304 enables control server 108 to receive incoming network packets from network 116 and send outgoing network packets to network 116. Network interface 304 may be embodied as network interface card (NIC) or a network adaptor, and may implement various network protocols and standards.

FIG. 3B is a block diagram of software components in control server 108, according to one embodiment. Memory 306 may store, among other software components, management module 310, operation support module 330, premises information 350A through 350C and object database 347. Memory 306 may store further software components not illustrated in FIG. 3B such as an operating system.

Management module 310 manages operators'accounts and provides functionalities for remotely accessing and controlling robots 104. For this purpose, management module 310 may include, among other components, access control module 312, transition support module 316, delegation module 318 and account database (DB) 320. Access control module 312 enables an operator to establish and manage accounts, including but not limited to, controlling access of one or more robots 104 by various users, including operators and users other than the operators. One or more of the users may be designated as operators to operate robots managed by control server 108. After the operator authenticates his or her identity on client device 112, access control module 312 checks user information in account database 320, and grants access to services provided by control server 108. For example, an operator may provide a combination of a user ID and password to access control server 108. The operator may then cause control server 108 to send various commands to robot 104 to perform tasks including navigation operations.

Transition support module 316 supports the transition to operate a robot or to transition between robots. Transition support module 316 may access information from account database 320 (e.g., initial setting information), and apply the accessed information when the operator attempts to operate robot 104. Further, when the operator decides to transition operation from one robot to another robot, transition support module 316 facilitates the transition by transferring certain information (e.g., settings) from the prior robot to the next robot. Transition support module 316 may also facilitate the transition between robots by generating and sending information about robots (e.g., currently captured images) to client device 112, as described below in detail with reference to FIG. 9. For example, if multiple robots 104 are available in the same facility, the operator may access one robot and then attempt to transition to another robot. The operator may make a selection to transition on client device 112 and transition support module 316 may switch the robot being accessed when the selection is made. In another example, multiple robots may be installed in different facilities and the operator may access robots in different facilities by transitioning between the robots.

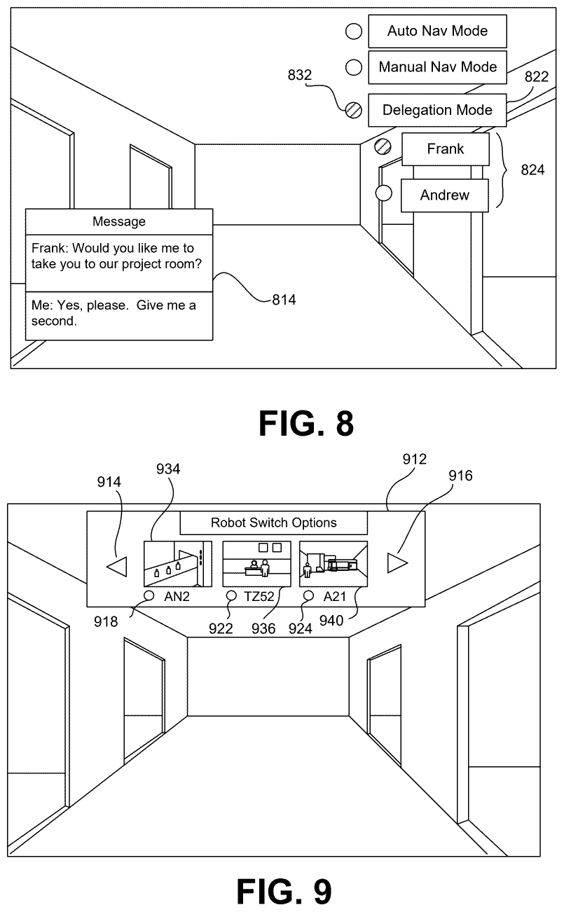

Delegation module 318 facilitates and supports delegation operations associated with the control of robot 104. When a delegation command to initiate a delegation mode is received from client device 112, delegation module 318 transfers the control of robot 104 from the operator to a person designated by the operator, as described below in detail with reference to FIG. 8. Information on persons to be delegated for operating robot 104 may be stored in account database 320. In one or more embodiments, the delegation command may include the identification of the person to be delegated with at least part of the robot.

Operation support module 330 includes software components for supporting performing tasks on robot 104. Depending on the modes of robot 104, different modules may be invoked or activated to control robot 104. In one embodiment, operation support module 330 includes mode selector 332, navigation support module 334, online control support module 336, simulation engine 338, machine learning module 340 and task database 341. Operation support module 330 may also include modules not illustrated in FIG. 3B such as software for performing visual recognition on images captured by robot 104.

Mode selector 332 is a software component that determines the mode in which robot 104 is to be placed and places robot 104 in that mode. Mode selector 332 may receive various mode switch commands and/or transition commands from client device 112, and places robot 104 in various modes. In one or more embodiments, the modes of robot 104 may be changed automatically when certain conditions are met.

Navigation support module 334 is a software component that provides support for navigation of robot 104 from a current location to a destination within its premises. Navigation support module 334 may perform one or more of the following operations: (i) retrieve environment map 342 and destination mapper 344 from premises information 350 and send them to robot 104 and/or client device 112, (ii) receive updated map information from robot 104 and update the environment map stored as part of premises information 350, (iii) perform SLAM algorithm for robot 104, (iv) perform one or more path planning algorithms based on the current position of robot 104 and the destination as identified by the operator, and (v) determine a coordinate of a destination in the environment map corresponding to an identifier received from client device 112 using destination mapper 344. When robot 104 generates sensor data, the sensor data may be sent in real-time to the server. Navigation support module 334 may pre-process the sensor data for the purpose of overcoming any latency, perform vision processing algorithms to generate information associated with the navigation of robot 104 from registered objects, tasks, robots, and equipment stored in memory 306 of control server 108. In one or more embodiments, the generated information may be shared with other robots and/or equipment on on-site and operators on-site or off-site. In the online mode, robot 104 may transmit sensor data, streaming images and a continuously updated map to navigation support module 334. Navigation support module 334, in response to receiving the data from robot 104, may process the data in real-time to compensate for latency, and perform vision processing to generates real-time information for sharing with other robots and equipment on-site, as well as the human operator at a remote location. Some of these operations may be performed on robot 104 or in conjunction with robot 104 in a distributed manner. In a manual navigation mode, navigation support module 334 receives navigation commands from robot 104 and streams them to robot 104 while streaming sensor signals (e.g., images captured by a navigation camera on robot 104) to client device 112 and detected coordinates of robot 104 to client device 112. In an autonomous navigation mode, navigation support module 334 may execute SLAM algorithm and one or more path planning algorithms to generate a path to the destination, and may send the generated path to robot 104.

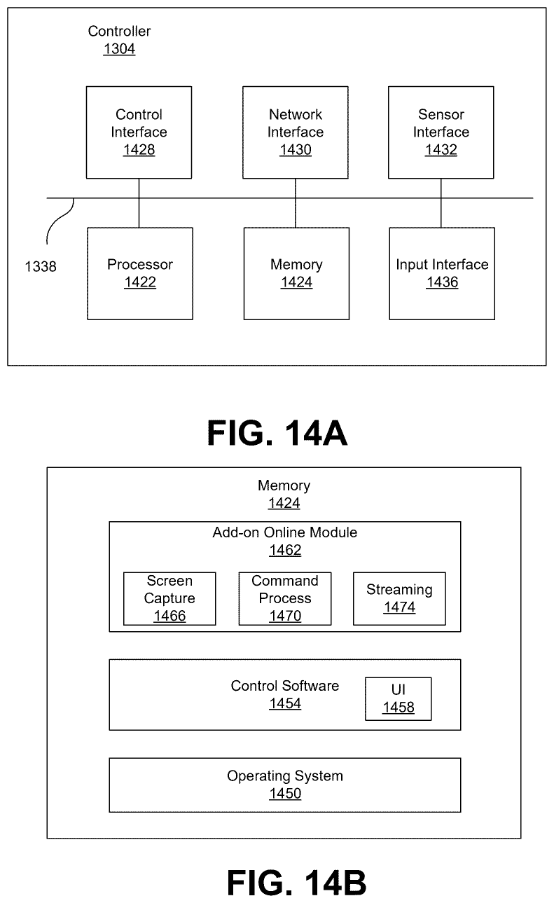

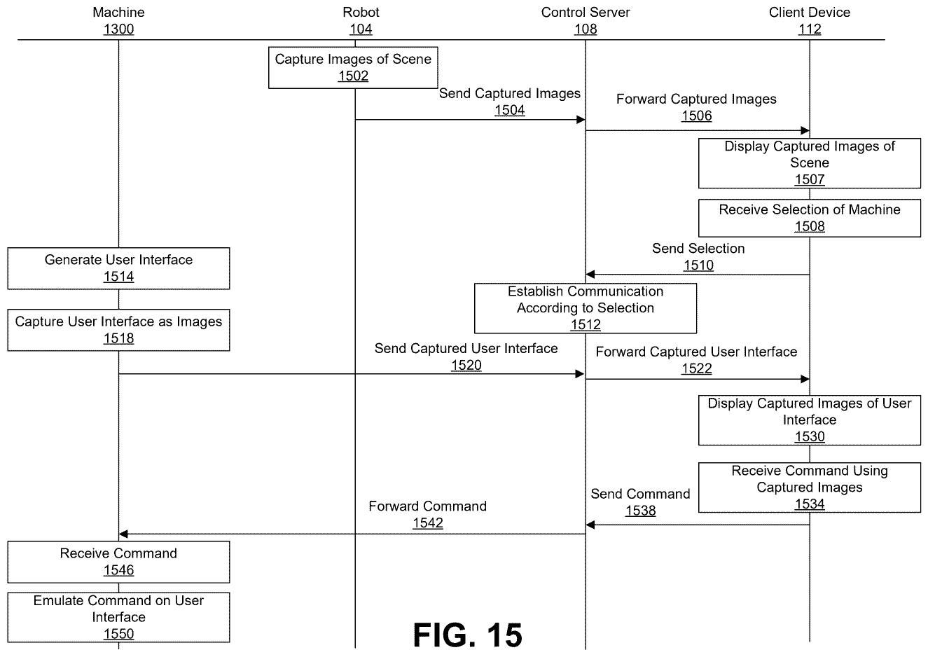

Online control support module 336 is a software component that supports online control of actuators in robot 104. When a manual actuator mode is active, online control support module 336 receives commands from client device 112 and streams these commands to robot 104. Online control support module 336 may perform additional operations such as filtering of commands or collision detection to ensure smooth and successful operations of actuators. In one or more embodiments, online control support module 336 may read equipment information 346 of the premises. When the command received from client device 112 relates to the manipulation of equipment (e.g., injection machine or conveyor belt) in the premises, online control support module 336 may facilitate the manual control of robot's actuators by taking certain actions on the equipment automatically (e.g., press “on” button) or warning the operator of likely consequences of taking the action (e.g., sending a message to client device 112 that the action will shut down the machine). Online control support module 336 may also stream images captured by a sensor (e.g., camera 206) of robot 104 to client device 112 to support the operations of actuators on robot 104. Online control support module 336 also forwards graphical user interfaces captured on machines to user devices and forwards commands received from the user devices to the machines, as described below in detail with reference to FIGS. 14 and 15.

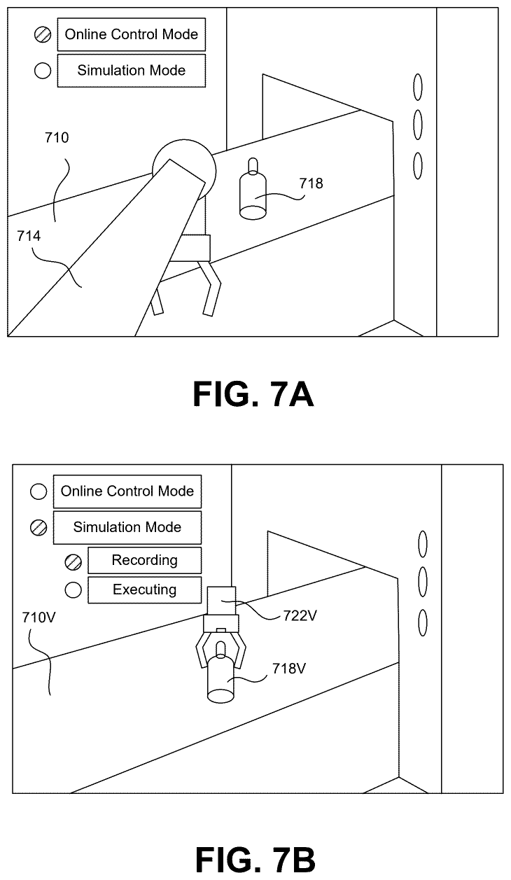

Simulation engine 338 is a software component that constructs a three-dimensional (3D) environment of robot 104 and performs simulation in such environment. Simulation engine 338 may be used to facilitate operations that the operator desires to perform by, among others, removing occluding objects from the operator's view, highlighting objects to be manipulated, and changing properties (e.g., pose or location of the object) or parameters (e.g., temperature of the object) associated with objects in the environment. An example of such an operation is described below in detail with reference to FIGS. 7A and 7B. Alternatively or in addition, simulation engine 338 may simulate operations of actuators of robot 104 and resulting changes in objects in the environment. The results of such simulations may be used by machine learning module 340 to generate machine learning models for performing operations using the actuators. Simulation engine 338 may also stream the simulation results for display at client device 112, using for example, APIs such as Web Graphics Library (WebGL) or Metal. Part or all of simulation engine 338 may also be provided at client device 112 instead of control server 108 and/or robot 104. To simulate the environment and interactions with objects and effectors (e.g., gripper) of robot 104, simulation engine 338 may include a physics engine to approximate a physical system such as rigid body dynamics.

Machine learning module 340 is a software component that generates or updates machine learning models for performing operations using the actuators of robot 104. The machine learning models may include various models including, but not limited to, convolution neural network (CNN) models (e.g., deep learning models and visual language models (VLMs)), probabilistic models, cognitive architecture models, hybrid models, imitation learning models, and supervised learning models. In one or more embodiments, a base machine learning model may be modified using a transfer learning technique to expand operations that may be performed by robot 104. That is, instead of performing the entire training of machine learning models on control server 108, partial training of the models may have been performed on other devices. Further, simulation results may be used to generate additional training data for the machine learning models. Machine learning module 340 may also leverage generative artificial intelligence (AI), using for example, transformers, to generate the training data. By leveraging simulation, partially trained machine learning models and/or transfer learning, machine learning models for diverse operations may be generated conveniently and efficiently. In one or more embodiments, the trained machine learning models may be sent to onboard computing device 216 of robot 104 for deployment and activation.

Task database 341 stores machine learning models and/or recorded operations of actuators corresponding to tasks that robot 104 may automatically perform. The stored machine learning models may be generated by machine learning module 340 or may be received from another source (e.g., robot 104 or client device 112). The recorded operations may be a sequence of operations for activating actuators of robot 104 to perform various tasks. In embodiments where onboard computing device 216 has a limited storage capacity available, a subset of the machine learning models or a subset of the recorded operations may be sent to onboard computing device 216 for deployment while onboard computing device 216 deletes machine learning models or recorded operations that have not been invoked for a predetermined amount of time or cycle.

Premises information 350 described herein refers to information on premises where robots 104 are deployed. Different premises information 350 may be provided for different premises or facilities. Premises information 350 may include, for example, environment map 342 of the premises or facility, destination mapper 344 (indicating mapping of identifiers to destination positions), and equipment information 346. An example of destination mapper 344 is described below in detail with reference to FIG. 5B. Equipment information 346 may indicate configurations, operational parameters, and positions of various machines on the premises. Premises information 350 may include information not illustrated in FIG. 3B such as the nature of the premises (e.g., factory, stadium, hospital) and the boundary of the premises.

Object database 347 described herein refers to a database or storage that stores various objects and their information. The information on the objects may be referenced by environment map 342 and equipment information 346 as well as simulation engine 338 and machine learning module 340 for identification and manipulation. Information on the objects may be received from various sources including client devices 112. The information in object database 347 may be sent to robots 104 and/or client device 112 for various operations. In one or more embodiments, object database 347 stores the dimensions of model objects. Such dimensions may be compared with the dimensions of actual objects detected by robot 104 to determine discrepancies or differences between the actual objects relative to the model objects. Object database 347 may also store various other properties of the objects such as locations of centers of gravity of objects, colors of the objects, texture of the objects, shapes of the objects, and actions or tasks associated with the objects.

### Architecture of Example Client Device

FIG. 4A is client device 112 for operating robot 104, according to one embodiment. Client device 112 of FIG. 4A is in the form of a head-mounted display device but client device 112 may take various other forms such as a portable computing device (e.g., a laptop computer or a tablet computer) or a stationary computing device (e.g., desktop computer). Client device 112 may include, among other components, body 410 and head strap 418 attached to body 410. Body 410 may include components such as cameras 414 for capturing the surrounding environment and control circuit 420.

FIG. 4B is a block diagram of control circuit 420, according to one embodiment. Control circuit 420 may include, among other components, processor 422, memory 424, input interface 426, display interface 428 (e.g., display driver circuits), network interface 430 and bus 432 connecting these components. Input interface 426 may communicate with wired or wireless controllers.

Memory 424 stores software components for execution by processor 422. Memory 424 may be embodied using various technologies or their combinations, including, for example, Random Access Memory (RAM), Read-Only Memory (ROM), flash memory, Hard Disk Drive (HDD), Solid-State Drive (SSD), virtual memory, magnetic tape and optical discs. Various software components stored in memory 424 are described below in detail with reference to FIG. 4C.

Processor 422 retrieves and executes commands stored in memory 424. Processor 422 may be embodied as a central processing unit (CPU), a graphics processing unit (GPU) or application-specific integrated circuits (ASICs). Although only a single processor 422 is illustrated in FIG. 4B, multiple processors may be provided in control circuit 420.

Network interface 230 enables control circuit 420 to receive incoming network packets from network 116 and send outgoing network packets to network 116. Network interface 230 may be embodied as network interface card (NIC) or a network adaptor, and implement various network protocols and standards.

Display interface 428 is hardware or hardware in combination with software that provides signals to a display device (not shown) on client device 112. Display interface 428 may include, for example, display driver circuits such as a gate driver and a data driver.

FIG. 4C is a block diagram of software components in client device 112, according to one embodiment. Memory 424 may store software modules including, among others, account access module 434, user interface module 438, location mapping application 442, environment storage 446, mode change detector 450, command streamer 454, simulation manager 458, and handover module 462. Memory 424 may store further software modules including, but not limited to, an operating system.

Account access module 434 is a software component that enables the operator to access services provided by control server 108. Account access module 434 may be embodied as a dedicated application or an Internet browser. In one or more embodiments, an operator enters verification information (e.g., ID and password) via account access module 434 to log into control server 108.

User interface module 438 generates graphical user interface screens associated with operating robots 104. User interface module 438 may receive data such as sensor information, object information, and parameters from control server 108, generate graphical user interface elements, and overlay these in various manners to display the operation of robots 104. In one embodiment, user interface module 438 synchronizes the movement of the camera on robot 104 with the movement of client device 112 so that the images from robot 104 are displayed on client device 112 in a VR, MR or AR mode in an immersive manner. For this purpose, user interface module 438 may operate in conjunction with command streamer 454 to send commands and sensor signals on the movement of client device 112 to control server 108. Example graphical user interface screens displayed on client device 112 are described below in detail with reference to FIGS. 6A through 10B.

Location mapping application 442 is a software component for navigating robot 104 to a desired destination. Location mapping application 442 may enable the operator to designate a certain location on the premises with identifiers as a target location, and use the identifiers to move robot 104 to the target location on the premises. For this purpose, location mapping application 442 may operate in conjunction with user interface module 438. Specifically, location mapping application 442 may (i) receive information on the mapping between locations in the premises and identifiers from control server 108, (ii) receive the mapping from the operator and store it in memory 424 or send it to robot 104 or control server 108 for adding or updating, and (iii) send mapping to user interface module 438 for display on client device 112.

An example operation of location mapping application 442 is described below in detail with reference to FIGS. 5A and 5B.

Environment storage 446 stores information on the premises where robot 104 operates. Environment storage 446 may store part or all of environment map 342, destination mapper 344 and equipment information 346 stored in control server 108. In one embodiment, environment storage 446 caches a small portion of environment map 342 to expedite navigation operations performed on client device 112. The remaining portions of environment map 342 may be fetched when needed from control server 108.

Mode change detector 450 is a software component used for switching the operation modes of robot 104. Mode change detector 450 may present options associated with changing the modes of operating robot 104 to the operator using user interface module 438, and operate in conjunction with control server 108 to place robot 104 in a mode selected by the operator. Modes available for operating robot 104 include, but are not limited to, (i) the autonomous navigation mode, (ii) the manual navigation mode, (iii) the online mode, (iv) the simulation mode, (v) the delegated mode, and (v) the trained mode.

Command streamer 454 is a software component that enables the streaming of commands to robot 104 in the online mode. The commands may be generated at client device 112 based on gestures or inputs received through controllers or other user interface devices (e.g., a keyboard or a pointing device). Command streamer 454 converts the user inputs received from the operator into commands, and sends the commands to robot 104 via control server 108 to operate robot 104. Command streamer 454 may also control robot 104 directly, bypassing control server 108. In some embodiments, command streamer 454 also receives sensed motions of client device 112, converts the sensed motions into commands, and sends them to robot 104 via control server 108.

Simulation manager 458 is a software component for operating in the simulation mode. Simulation manager 458 operates in conjunction with simulation engine 338 to simulate the operations of robot 104 in the simulation mode. Specifically, simulation manager 458 interoperates with simulation engine 338 to display robot 104 and simulated 3D environment in which robot 104 operates, receives input from the operator indicating the operations of actuators, and generates an updated display showing the result of the actuator operations. To display the relevant graphical user interface screens, simulation manager 458 may interoperate with user interface module 438, for example, as described below in detail with reference to FIGS. 7A and 7B.

Handover module 462 is a software module that supports the transition to and from operating robots 104. The operator may be authorized to control a plurality of robots 104. In such case, handover module 462 may be used to switch the robot being activated by the operator's client device 112. Handover module 462 interoperates with user interface module 438 to present options to switch between robots, as described below in detail with reference to FIG. 9. Handover module 462 may interoperate with management module 310 of control server 108 to smoothly transition from operating one robot to operating another robot. Further, handover module 462 may operate with delegation module 318 of control server 108 to hand over operations of at least a part of robot 104 to a delegated person. For this purpose, handover module 462 may present operations on the persons to be delegated, generate the delegation command in response to receiving selection from the operator, and send the delegation command to control server 108.

### Example Autonomous Navigation

Embodiments provide various ways to move robot 104 autonomously to a desired destination. One way of designating the desired destination is by using an identifier of the desired destination. Another way is to designate the desired destination using a map such as a two-dimensional (2D) floorplan or a 2D map. Input for identifying the desired destination may be received at client device 112 in various modalities such as point and click, gestures and/or verbal commands.

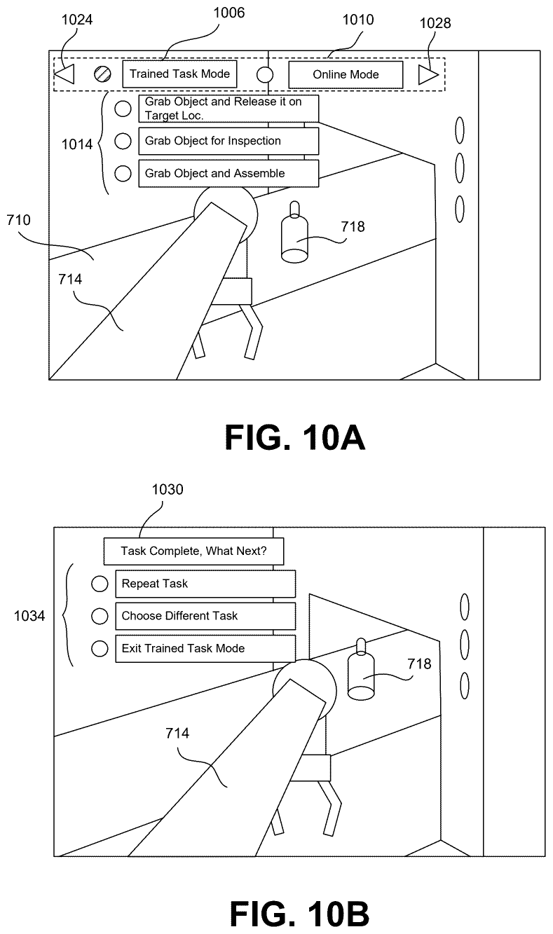

FIG. 5A is an example environment map of the premises, according to one embodiment. The environment map may be stored and updated in one or more of control server 108, robot 104 and client device 112. In FIG. 5A, the environment map is represented in the form of a 2D floorplan or a 2D map 512. Taking the example of FIG. 5A, the premises include eight rooms that are accessible by a common corridor. Locations on the premises may be designated by identifiers. In the example of FIGS. 5A, 10 locations P1 through P10 in the premises are preassigned by the operator or others.

FIG. 5B is example destination mapper 514 indicating mapping between identifiers and assigned locations, according to one embodiment. Destination mapper 514 may be embodied as a lookup table. In the example of FIG. 5B, the identifiers of loader, machine A, shelf X and fabricator are assigned to locations P1, P2, P3 and P10, respectively. By using identifiers, the operator may conveniently provide commands to take actions on robot 104, for example, by providing a verbal command on client device 112 (e.g., provide a verbal command such as “move to shelf X”).

FIG. 6A is a graphical user interface diagram showing graphical user elements for selecting a navigation mode, according to one embodiment. Radio buttons 614, 618 are displayed on a screen to enable the operator to choose between an autonomous navigation mode and a manual navigation mode. By choosing radio button 614, robot 104 is placed in the manual navigation mode where the operator manually operates robot 104 to move it in a desired direction at a desired speed. By choosing radio button 614, robot 104 is placed in the autonomous navigation mode where robot 104 may autonomously move to a location on the premises designated as the destination. In FIG. 6A, information on the current location of robot 104 is identified in box 610. These user interface elements (e.g., box 610, and radio buttons 614, 618) are overlaid on image 602 that is captured by a camera (e.g., camera 206) on robot 104.

FIG. 6B is a graphical user interface diagram displayed when radio button 618 is selected, according to one embodiment. In this embodiment, destination selection window 636 is launched in the autonomous navigation mode. Destination selection window 636 may be launched immediately after radio button 618 is selected or an additional command (e.g., a verbal command or gesture) may be provided using client device 112 to launch destination selection window 636. Destination selection window 636 includes multiple locations P1 through P10 for selection as the destination to be reached by robot 104. Each of the locations P1 through P10 may be associated with a location in the premises as defined by destination mapper 514. After destination selection window 636 is displayed, the operator may make the selection of the destination using various input methods such as gazing at the location followed by a gesture (e.g., a pinching or flicking motion of fingers) or moving a cursor on the screen using a controller or a pointing device (e.g., a mouse) followed by clicking a button on the controller or the pointing device. In the example of FIG. 6B, location P3 is selected and the selection is displayed in box 630.

FIG. 6C is a graphical user interface diagram including image 602 overlaid with environment map 640 of the premises, according to one embodiment. Environment map 640 may be presented as an alternative to or subsequent to displaying of destination selection window 636 of FIG. 6B. Environment map 640 may be displayed as a 2D layout of the premises. In environment map 640, a current position of robot 104 may be represented by a user interface element 648 while the locations P1 through P10 on the premises preassigned with identifiers are displayed as white dots. In the example, the operator selects one of the dots (e.g., dot 644) to instruct robot 104 to move to a location corresponding to dot 644. The selected dot may be displayed in a prominent manner (e.g., highlighted or displayed in a different color) to notify the operator that the destination has been selected. In one or more embodiments, instead of selecting dots, the operator may select a location not preassigned with identifiers. By displaying the 2D representation of the environment map of the premises and allowing the operator to choose the destination on the displayed environment map, the operator may conveniently and intuitively navigate robot 104 to the desired destination.

In one or more embodiments, a hybrid navigation mode may also be provided to operate robot 104. In the hybrid navigation mode, the movements of robot 104 are determined autonomously by autonomous navigation module 256 and/or navigation support module 334 while the movement of robot 104 may continue to be controlled at least partially by the operator through manual commands. For instance, the movement of robot 104 determined by autonomous navigation module 256 may be blended with manual navigation commands received via client device 112. The degrees of weights (e.g., an alpha value) given to the autonomous movements and manual operations may be set by the operator or may be varied according to various factors (e.g., moving speed of robot 104). Further, automatic operations to prevent collision (e.g., halting robot 104 before crashing into a wall) may be performed to prevent hazardous or undesirable conditions/events due to partial manual control of robot 104.

### Example Operation in Simulation Mode

In the simulation mode, operations involving accurate timing or sensitive movements may be simulated in a 3D environment to record operations or train a machine learning model as performed by the operator, and have robot 104 repeat the recorded or trained operations. The simulated 3D environment may be a virtualized version of the real environment in which robot 104 operates, and may reference various types of data in control server (e.g., information in object database 347 and equipment information 346) as well as data received from robot 104 (e.g., location of objects detected by processing sensor signals from sensors 211) and/or other sources. Such virtualized version of the real environment may be generated, for example, by scanning the environment using a depth sensor and/or camera 206 on robot 104. Alternatively, the virtualized version of the real environment may be generated using a device other than robot 104 or constructed based on floor plan of the environment. Information on the simulated 3D environment and any interactions between objects in the 3D environment may be generated by simulation engine 338 and be sent to client device 112. Client device 112 may render images according to the information on the 3D environment and its objects as received from simulation engine 338 as a VR, MR or AR.

Due to factors such as network latency and processing delays at robot 104 or control server 108, it may be difficult to timely take actions or may involve an excessive amount of time or repetition to achieve results as desired by the operator. For example, when the operator desires to have robot 104 grab and pick up an object moving on a conveyor belt, as shown in FIG. 7A, delays due to processing or communication may result in the failure of the operations. Further, part of robot 104 or other objects may occlude the view of the camera, further hindering the accurate or timely operations of robot 104 by the operator. In such cases, direct online control of robot 104 by the operator may be impractical or infeasible to achieve a target goal. Hence, robot 104 may be trained to perform these operations autonomously by using recorded or trained actions in the 3D environment.

FIG. 7A is a graphical user interface diagram illustrating an online operation of picking up object 718 by a manipulator or arm assembly 714 with a gripper at its end, according to one embodiment. Robot 104 is in an online mode to pick up object 718 moving along a conveyor belt 710. However, due to the speed or lag time associated with controlling the manipulator or arm assembly 714, the operator may experience difficulty in performing this task in the online mode. Further, a member of the manipulator or arm assembly 714 extending across the screen may also obstruct the view of object 718, rendering the desired operation more difficult.

The simulated environment of FIG. 7B may be generated by simulation engine 338. To accurately simulate the objects and environment, simulation engine 338 may receive some or all of the following information: (i) information on objects/equipment in the environment as sensed by sensors 211 of robot, (ii) object information in object database 347, (iii) equipment information 346, (iv) information on the pose of robot 104 (e.g., pose of arm assembly 214), (v) the configuration of robot 104 (e.g., dimensions of members in arm assembly 214 and permissible rotation angles of joints 210 connecting the members), and (vi) information on the premises. Simulation engine 338 may include a physics engine to replicate real physical interactions more accurately between objects in the virtually reconstructed scene.

Training or recording to perform tasks may be performed in the simulation mode by receiving operating commands from the operator via client device 112. In the training mode, the operator may perform a series of operations by sending commands to control server 108. As a result, control server 108 performs a simulation of the operations according to the commands received from client device 112 in the simulated environment, and returns the simulated result to the client device 112 for display. The simulated result may be presented on the client device 112 in real-time, and the operator may make adjustments to correctly perform the desired task. In one or more embodiments, the simulated result is displayed on client device 112 by user interface module 438 that interoperates with simulation engine 338 using WebGL or metal.

Taking the example of FIG. 7B, the simulation of virtual object 718V (a reconstructed version of object 718 sensed by sensors 211) moving along a virtual conveyor belt 710V (a reconstructed version of conveyor belt 710 sensed by sensors 211) is generated and displayed on client device 112. A virtual gripper 722V is also displayed in FIG. 7B without the occlusion caused by manipulator or arm assembly 714. The operator may record the operations or train a machine learning model to pick up virtual object 718V by moving and activating virtual gripper 722V in the simulated environment. The recorded action or training data derived from the operator's actions in the simulated environment may be sent to robot 104 so that robot 104 may autonomously perform the operation of picking up and moving object 718 in the trained mode. After the initial training, the operator may select to execute the recorded actions or trained operations in the 3D simulated environment, for example, by pressing the radio button of “Executing” in FIG. 7B. Once the operator determines that the correct operations are performed in the simulated environment, the operator may instruct the recorded action or the trained model to be stored in and/or be deployed at robot 104.

When the models are embodied as machine learning models, various techniques such as transfer learning, data augmentation and synthetic data generation may be used to facilitate the training of the models. After the initial training of the models is performed, techniques such as pruning, quantization of weights, knowledge distillation, and low-rank factorization may be performed to reduce the size of the machine learning models or speed up the machine learning model. In one or more embodiments, the machine learning models used by simulation engine 338 may include, among others, convolution neural network (CNN) models (e.g., deep learning models and visual language models (VLMs)), probabilistic models, cognitive architecture models and hybrid models which compiles multiple models.

### Example Operation in Delegation Mode

In a delegation mode, the operator of robot 104 may delegate partial operations or the entire operations of robot 104 to another person. The person delegated by the operator may be, for example, someone more familiar with the premises or equipment installed on the premises. In one or more embodiments, the delegated person may also have an account on control server 108. When the operator sends a command to authorize the person to take over the control of robot 104 using client device 112, delegation module 318 passes commands from the delegated person to robot 104 so that the delegated person may control at least part of robot 104.

FIG. 8 is a graphical user interface diagram for activating the delegation mode of the robot, according to one embodiment. In the example of FIG. 8, text boxes with radio buttons at their left sides may be displayed to enable the operator to choose a mode of operating robot 104. One of the modes is the delegation mode as shown by text box 822. When the operator selects the delegation mode by activating radio button 832, additional text boxes 824 may be presented to enable the operator to choose the person to be delegated to control robot 104.

When the selection of the person (e.g., Frank) to be delegated with the control of robot 104 is made by the operator (e.g., by activating the radio button), user interface module 438 of client device 112 sends a delegation command to delegation module 318 of control server 108 to enable the selected person as the delegated operator to take over control of at least a part of robot 104. The delegation command may include information or identification of the selected person and/or the degree or level (e.g., full control of the robot or partial control of driving motors 208 and wheels 212) at which the selected person is authorized to control robot 104. In one or more embodiments, the person to be selected for designation has an account in control server 108, and is located remotely from the operator.

A communication channel may be provided to facilitate the communication between the operator and the person to be delegated or previously delegated to control robot 104. For example, a messenger box 814 is displayed on the screen to enable the operator and the delegated person to exchange messages associated with the delegation. Alternative to or in addition to presenting messenger box 814, verbal communication channels may be established to enable the operator and the person to communicate verbally using their client devices 112.

The delegation mode may be used in various contexts. In the example of FIG. 8, the delegated person may take over the navigation operation of robot 104 and manually operate and move robot 104 to a target location (e.g., project room). In another example, the operator may delegate the operation of robot 104 to an expert or maintenance person to manipulate equipment on the premises. The expert or the maintenance person may teleoperate robot 104 to perform tasks that otherwise would have involved their physical presence at the premises. In yet another example, the delegated person may operate robot 104 to a preassigned location in an event venue (e.g., a concert stadium) and later hand over the control back to the operator so that the operator may experience telepresence at the event venue.

In one or more embodiments, the operator may continue to receive updates from robot 104 in the delegation mode. For example, the operator's client device 112 may receive images captured by robot 104 so that the operator remains informed about the operations and status of robot 104. Further, the operator may delegate partial control of robot 104 and retain the remaining control of robot 104. For example, the operator may only allow the delegated person to control driving motors 208 and wheels 212 so that the person may move robot 104 to a target location while the operator continues to retain the control of other actuators of robot 104 (e.g., actuators for controlling camera). The actuators or tasks authorized for delegation may be stored in delegation module 318 or account database 320.

After the task delegated by the operator is accomplished, the operator may take back the operation of robot 104. This may be accomplished, for example, by inactivating radio button 832 on the screen of the operator's client device 112 as shown in FIG. 8. Alternatively, the person delegated with the task may terminate the delegation by taking actions on that person's client device 112. The delegated person may also take actions on his or her client device to release the operation of the robot.

### Example Transition Operation

The operator may choose to operate a robot or transition from operating one robot to another robot. Client device 112 may operate in conjunction with transition support module 316 of control server 108 to present options on robots to be controlled by the operator, and enable the operator to control the chosen robot.

Specifically, when client device 112 sends a command to control server 108 to start the operation of transitioning to control of the other robot, transition support module 316 sends information on available robots for transition to client device 112. The robots available for transition may be stored in account database 320. Client device 112 may also send additional information associated with the robots for transition such as images captured by these robots to client device 112. Once client device 112 receives the information on the available robots, client device 112 may present the options on its display. Then, the operator may choose one of the available robots for the transition by making the selection on client device 112. After the selection is made, operating commands from client device 112 may be forwarded by control server 108 to the transitioned robot while information (e.g., captured images) from the transitioned robot received by control server 108 is forwarded to client device 112.

By enabling the operator to switch to operations of different robots, the operator may conveniently perform various tasks using a robot that is appropriate for the desired tasks. Such transition to operate another robot is made convenient on the same client device so that the operator may seamlessly perform various tasks.

FIG. 9 is a graphical user interface diagram for enabling the operator to transition to another robot, according to one embodiment. When requested by the operator or when certain conditions are met, client device 112 may present the graphical user interface of FIG. 9 where an area 912 of the screen displays options to transition to another robot. In the example of FIG. 9, three other robots AN2, TZ52, and A21, and the images 934, 936, 940 of their environment captured by these robots are displayed in area 912. Additional or alternative robots may be displayed for selection by activating right or left arrows 914, 916.

When one of the robots shown in area 912 is selected by clicking one of radio buttons 918, 922, 924, client device 112 sends a transition command to control server 108 requesting the transition of the robot being controlled and the identification of the robot. Transition support module 316 of control server 108 then takes actions to hand over the operation of the newly selected robot to the operator. Such operations may include, among others, initializing the newly chosen robot, sending information on the selected robot to client device 112, and forwarding the commands received from client device 112 to the newly chosen robot.

Different ways may be used to select the robot for transition. For example, instead of using area 912, the operator may provide verbal commands (e.g., “transition to the robot in room A”). Alternatively, a 2D layout of the premises similar to what is in FIG. 6C along with the identification on locations of the robots for selection may be displayed on client device 112 and the selection of the robot may be made on the 2D layout.

### Example Operation in Trained Mode

Robot 104 may be operated in a trained mode where robot 104 performs trained tasks or recorded versions of the operator's control commands. When a trained task is selected by the operator, information associated with the task is retrieved from task storage 268 and loaded onto task execution module 267. Then, the task execution module 267 performs autonomous operations to execute the loaded task.

For this purpose, task execution module 267 may receive the sensor signals from sensor processor 244 and generate control signals for sending to actuator controller 246 or directly to actuators. The task execution module 267 may also reference information within robot 104 (e.g., any object information or equipment information stored in memory 224), and/or information received from control server 108 (e.g., object information from object database 347).

By operating robot 104 in the trained mode, the operator may conveniently achieve the desired result of the trained task despite lag in communication from client device 112 to robot 104 and/or occlusion in the images captured by a camera on robot 104. Further, robot 104 may also perform repeated tasks without the operator having to manually repeat the control on robot 104.

FIGS. 10A and 10B are graphical user interface diagrams for choosing and executing trained tasks using robot 104, according to embodiments. In area 1010 of the screen on client device 112, modes for operating robot 104 are displayed for the operator's selection. The operator may choose one of the modes by activating a radio button on the left side of mode boxes 1006. The operator may view more options of modes by activating left or right arrows 1024, 1028 in area 1010.

When mode box 1006 corresponding to the trained mode is selected, boxes 1014 corresponding to trained or recorded tasks for the operator's selection are displayed on the screen. The operator may choose one or more of the radio boxes to initiate automatic control of robot 104 to initiate operations to accomplish the tasks corresponding to the selected radio boxes. The graphical user interface elements (e.g., mode boxes, task boxes and arrows) and their layout illustrated in FIG. 10A are merely an example, and various other changes may be made to the graphical user interface elements and their layout on the screen.

In the example of FIG. 10A, when the first task “grab object and release onto a target location” is selected, task execution module 267 sends commands to operate arm assembly 714 and its gripper to actuator controller 246 so that the gripper picks up object 718 from conveyor belt 710 and releases object 718 on a target location (e.g., another conveyor belt). When the second task “grab object for inspection” is selected, task execution module 267 sends commands to actuator controller 246 to grab object 718 using the gripper and take measurement using a sensor installed on the gripper. When the third task “grab object and assemble” is selected, execution module 267 sends commands to actuator controller 246 so that the gripper grabs the object 718 and then robot 104 takes a series of operations to assemble object 718 onto another object, as previously trained. These tasks are merely illustrative, and various other tasks may be trained and executed on robot 104.

FIG. 10B is a graphical user interface diagram displayed after the task selected by the operator is completed, according to one embodiment. Once the task is completed, a task completion box 1030 is displayed on the screen of client device 112 and text boxes 1034 corresponding to options associated with the completion of the task. The options may include, for example, repeating the same task, choosing a different task for execution, and exiting the trained task mode. If the operation of choosing the different task is selected, the robot stays in the trained task mode but other tasks for selection are displayed on client device 112. After exiting the trained task modes, the screen may revert to the menu as displayed, for example in FIG. 10A, enabling the operator to choose a different mode of operating client device 112.

The graphical user interface elements and their layouts described above with reference to FIGS. 10A and 10B are merely illustrative. The graphical user interface elements other than ones illustrated above with reference to FIGS. 10A and 10B, and different layouts of user interface elements may be displayed in association with the trained mode.

### Example Methods of Switching Operating Modes

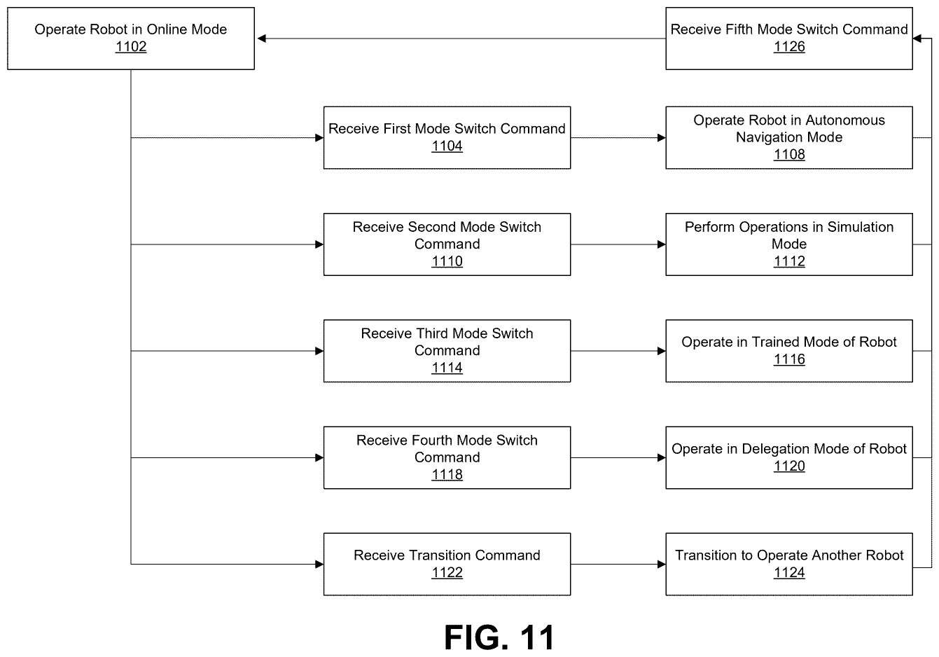

FIG. 11 is a flowchart illustrating a method of operating the robot, according to one embodiment. Robot 104 is placed in the online mode to operate 1102 robot by streaming commands from client device 112. In this mode, the operator sends operating commands from client device 112 to robot 104 via control server 108 or directly from client device 112 to robot 104.

A first mode switching command may be received 1104 from client device 112. The first mode switching command may be generated by client device 112 and sent to control server 108, for example, when the operator activates a graphical user interface element such as radio button 614 shown in FIG. 6A. In response to receiving the first mode switching command, robot 104 and/or control server 108 switches to the autonomous navigation mode and operates 1108 robot 104 in the autonomous mode. In the autonomous navigation mode, the operator may designate a destination, for example, by selecting an identifier (as shown in FIG. 6A) of the destination or selecting a dot on a 2D environment map (as shown in FIG. 6C).

Alternatively, a second mode switching command may be received 1110 from client device 112. The second mode switching command is generated by client device 112 and sent to control server 108, for example, when the operator activates a graphical user interface element such as a radio button shown in FIG. 7A. In response to receiving the second mode switching command, operations are performed 1112 in the simulation mode where control server 108 generates a virtual version of the environment and a virtual version of robot 104 for training, as shown in FIG. 7B.

A third mode switching command may be received 1114 from client device 112. The third mode switching command is generated by client device 112 and sent to control server 108, for example, when the operator activates a graphical user interface element such as a radio button shown in FIG. 10A or 10B. In response to receiving the third mode switching command, robot 104 is operated 1116 in the trained mode where a trained machine learning model or a recorded version of robot operations is loaded onto robot 104 and executed.

Alternatively, a fourth mode switching command may be received 1118 from client device 112. The fourth mode switching command is generated by client device 112 and sent to control server 108, for example, when the operator activates a graphical user interface element such as a radio button shown in FIG. 8. In response to receiving the fourth mode switching command, robot 104 is operated 1120 in the delegation mode where robot 104 is at least partially operated by a person delegated by the operator. The person to be delegated may be selected on client device 112 by using radio buttons next to additional text boxes 824 in FIG. 8.

Further, a transition command may be received 1122 from client device 112. The transition command is generated by client device 112 and sent to control server 108, for example, when the operator activates a graphical user interface element such as one of the radio buttons 918, 922, 924 shown in FIG. 9. In response to the transition command, control server 108 transitions 1124 to enable the operator to operate the robot identified in the transition command.

When a fifth mode switch is received 1126 from client device 112 with the robot in a mode other than the online mode, the operation of the robot may switch back to the online mode.

The steps and their sequences in FIG. 11 are merely illustrative. Although FIG. 11 illustrates switching to the autonomous navigation mode, the simulation mode, the trained mode, the delegation mode and the transitioning to another robot only from the online mode, the switching may occur from modes other than the online mode to other modes. For example, a switching of mode from the autonomous mode to other modes (e.g., the simulation mode, the trained mode, and delegation mode) may occur when corresponding switch commands are received.

### Proxy Robot Control Functionality

In various modes of operation described herein, a first robot may function as a proxy for operating related equipment or a second robot or equipment. The first robot and the related equipment or the second robot may communicate via wired or wireless communication to perform various tasks and expand the capability of the first robot. By controlling the second robot or equipment by the first robot, the types and range of tasks that may be performed by the first robot may be expanded. The second robot or equipment, on the other hand, may be provided with limited functions and capabilities relative to the first robot. Due to such limited function and capabilities, the second robot or equipment is less expensive to produce and deploy. Hence, the capabilities of the first robot may be expanded cost effectively by using the second robot or equipment.

The communication between the first robot and the second robot or equipment may be performed using various mechanisms and communication protocols. For example, communication between the first robot and the second robot or equipment may be established using wireless communication protocols (e.g., Bluetooth, WiFi and Zigbee) or a wired communication protocol (e.g., PROFINET, EtherCAT and EtherNet/IP). In one embodiment, a master-slave relationship is established between the first robot and the second robot or equipment.

Taking the example of FIGS. 7A and 7B, robot 104 may send signals to a controller of conveyor belt 710 to start/stop its operation or control the speed the conveyor belt 710. For this purpose, the controller of conveyor belt 710 is equipped with a network interface for communicating with network interface 230 of robot 104. In controlling the conveyor belt 710, robot 104 may use its sensors (e.g., camera 206) to detect the status of operations associated with conveyor belt 710.

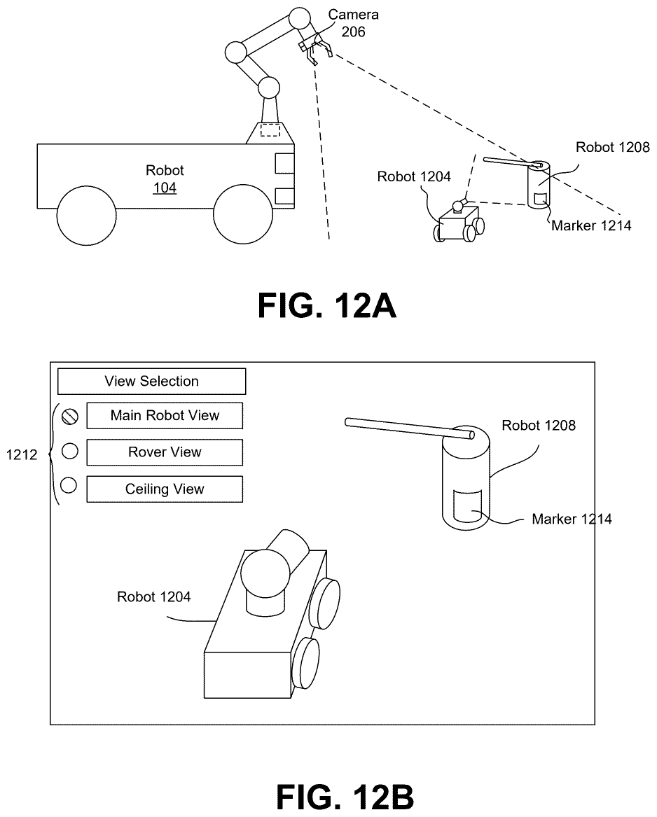

In another example of FIG. 12A, robot 104 may operate as the first robot that controls robot 1204 and robot 1208 as the second robots via wired or wireless communications to navigate robot 1204 and actuate robot 1208. Robot 104, as described above with reference to FIGS. 2A and 2B, includes hardware and software components to communicate with control server 108 and client devices 112 to perform tasks in various operation modes. Conversely, robot 1204 and robot 1208 may be robots with limited functionality and capabilities (e.g., sensing capabilities and computing capabilities). In such configurations of robots 1204, 1208, these robots 1204, 1208 may receive commands and instructions via robot 104 instead of directly communicating with server 108 and client devices 112. Further, operations to be performed by robots 1204, 1208 that involve a large amount of computation or memory resources may be performed by robot 104 or control server 108. Commands and instructions resulting from the operations may be provided to robots 1204, 1208 via or from robot 104.

In this example, camera 206 of robot 104 tracks robot 1204 and provides commands to robot 1204 to navigate to robot 1208 with or without the intervention of a human operator, depending on the mode of operation. Robot 1204 may also be equipped with a camera that may provide image feed to robot 104 via wired or wireless communication. Robot 104 determines locations of robots 1204, 1208 and executes motion planning or path planning operations using the images captured by camera 206 and/or the image feed from robot 104 and sends control signals in real time to guide robot 1204 to a location close to robot 1208. After robot 1204 reaches the desired location, robot 104 may send commands to robot 1208 to take certain actions (e.g., pickup a payload from robot 1204).

FIG. 12B is a graphical user interface diagram illustrating images captured by camera 206 of robot 104, according to one embodiment. The human operator may select view for operating robots 1204, 1208 via robot 104. Radio buttons 1212 in FIG. 12B may be selected to by the human operator to view robots 1204, 1208 in a desired orientation. In the example, the view of the scene may be captured using camera 206 of robot 104 (“Main Robot View”), a camera mounted on robot 1204 (“Rover View”) or a camera mounted on the ceiling of the facility (“Ceiling View”). When Rover View is selected, the image feed in the first-person point of view from robot 1204 is sent to robot 104 and then provided to client device 112 whereas when “Main Robot View” or “Ceiling View” is selected, the image feed in the third-person point of view from robot 104 or the ceiling camera is provided to client device 112. In the online mode, any commands to control robots 1204, 1208 received from client device 112 may be relayed by robot 104 to robots 1204, 1208.

Although the example of FIGS. 12A and 12B are described in the context of operating only two robots 1204, 1208 by robot 104, in practice, robot 104 may operate sense operations and control many more robots. By reducing the number of sensors and simplifying the robots controlled by robot 104, diverse tasks may be accomplished in a more expedient and cost-effective manner.

Robots or machines may be provided with identifiers such as markers or tags to facilitate their identification. Although the identity of the robots or machines may be determined based on their positions, identifiers may be provided on the robots or machines to better identify them. The identifiers may be visual codes such as QR codes, bar codes, and color codes. Taking the example of FIGS. 12A and 12B, marker 1214 in the form of a QR code may be imprinted on robot 1208. When robot 104 or robot 1204 captures a scene including marker 1214, the captured image may be analyzed to detect marker 1214. Marker 1214 may indicate identity of robot 1208, which may be stored as part of equipment information 346.

### Teleoperation of Machines Using User Interface Capture

Manufacturing Execution Systems (MES) are software solutions used in factories and other manufacturing facilities to monitor, control, and improve production processes in real-time. MES serves as a bridge between enterprise-level planning systems and shop floor operations, tracking the transformation of raw materials into finished products. However, the use of MES presents its own challenges. Manufacturing environments often include a mix of legacy and modern equipment from various vendors, each with its own proprietary protocols and data formats. This diversity creates significant challenges in integrating and coordinating these disparate systems within an MES framework. The use of equipment from different manufacturers exacerbates these issues, as each device may have unique communication protocols, data structures, and operational requirements. Consequently, troubleshooting becomes a complex task, requiring expertise in multiple systems and the ability to navigate through various interfaces and data formats. Even with MES deployment, the lack of standardization across vendors can lead to data inconsistencies, communication gaps, and operational inefficiencies, making it difficult to achieve seamless integration and optimal performance across the manufacturing floor.

Embodiments enable remote access, monitoring and troubleshooting of multiple machine or robots in a facility by visually inspecting them using a camera that may be mounted on a robot. User interfaces of the machines or robots in the facility are then captured as images and sent to the user device for presentation to the user. After reviewing the scene captured by the camera and the images of the user interfaces on the client device, the user may issue commands on the client device to emulate user actions on the user interfaces of the machines or robots. Such a scheme of capturing the user interfaces as images and emulating the user inputs on the user interfaces alleviates the complexity associated with the deployment of MES or other middleware for coordinating operations of the disparate machines or robots in the facility.

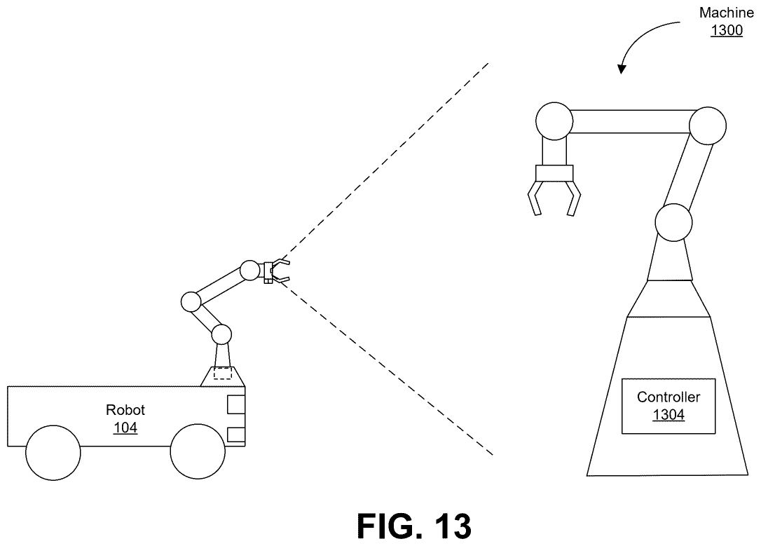

FIG. 13 is a diagram illustrating robot 104 capturing a scene including machine 1300 using its camera 206, according to one embodiment. Robot 104 includes camera 206, as described above with reference to FIG. 12A. Images captured by camera 206 are sent to client device 112 via control server 108 so that the user may visually perceive machine 1300 and its status. Based on the captured images and/or other information, the user may control machine 1300 using client device 112 by sending commands to machine 1300 directly or via control server 108.

For this purpose, machine 1300 may include controller 1304. Controller 1304 receives sensor signals from sensors on machine 1300, executes software programs to operate actuators of machine 1300, and communicates with control server 108. Controller 1304 may be native to machine 1300 or may be installed as an accessory or an after-market component to customize or expand functionality of machine 1300. Although machine 1300 is illustrated as a stationary device in FIG. 13 to facilitate understanding, machine 1300 may be embodied as another robot or a mobile device. Further, machine 1300 may also include its own camera to capture images, and send the captured images to client device 112 via control server 108. In such a case, the images captured by the camera of the machine 1300 may be used as an alternative to or in addition to the camera on robot 104.

FIG. 14A is a block diagram of controller 1304, according to one embodiment. Controller 1304 may include, among other components, control interface 1428, network interface 1430, sensor interface 1432, processor 1422, memory 1424 and input interface 1436. In some embodiments, controller 1304 may omit one or more of these components (e.g., sensor interface 1432) or include additional components.

Control interface 1428 is hardware or hardware in combination with software that controls actuators or effectors of machine 1300, such as motors. For this purpose, control interface 1428 receives instructions from processor 1422, generates control signals, and sends the control signals to the actuators. Control interface 1428 may also receive feedback signals from the actuators to perform more accurate operation of actuators.

Network interface 1430 enables controller 1304 to communicate with control server 108 and client device 112. Network interface 1430 may be embodied as a network interface card (NIC) or a network adaptor, and implement various network protocols and standards.

Sensor interface 1432 is hardware or hardware in combination with software that interfaces with sensors in machine 1300. Sensors may detect various physical properties to enable machine 1300 to perform its operations. Sensor interface 1432 sends control signals to control the operation of sensors and/or receives sensor signals from the sensors for further processing by processor 1422.

Processor 1422 may be embodied as a central processing unit (CPU), a graphics processing unit (GPU) or application-specific integrated circuits (ASICs). Although only a single processor 1422 is illustrated in FIG. 14A, multiple processors may be provided in controller 1304.

Memory 1424 stores software components for execution by processor 1422 to operate machine 1300 and/or to interoperate with client devices 112 and control server 108. Memory 1424 may be embodied using various technologies or their combinations, including, for example, Random Access Memory (RAM), Read-Only Memory (ROM), flash memory, Hard Disk Drive (HDD), Solid-State Drive (SSD), virtual memory, magnetic tape and optical discs. Various software components stored in memory 1424 are described below in detail with reference to FIG. 14B.

Input interface 1436 is hardware or hardware in combination with software that receives data from external sources. The external sources may include user interface devices such as a pointing device and keyboard.

FIG. 14B is a block diagram of software components in memory 1424 of controller 1304, according to one embodiment. The software components may include, among others, operating system 1450, control software 1454, and add-on online module 1462. Memory 1424 may store various other software components in addition to components shown in FIG. 14B.

Operating system 1450 is a software component for managing resources of controller 1304. Operating system 1450 includes, for example, Windows, Linux and Real-time Operating Systems (RTOS). In some embodiments, specialized or proprietary operating systems tailored for specific industrial application are used.

Control software 1454 is a software component that operates in conjunction with control interface 1428 to control various aspects of machine 1300. Control software 1454 may manage and issue commands to set parameters, conditions and/or sequences for operating one or more operations of actuators or effectors in machine 1300. Control software 1454 also includes user interface 1458 that generates information displayed to a user via a display device (e.g., a control panel). User interface 1458 also operates in conjunction with input interface 1436 (e.g., a keyboard, a pointing device and a touchscreen) to receive commands and instructions from the user. In some embodiments, control software 1454 is designed and programmed to operate with a display device that is installed on machine 1300.

Add-on online module 1462 is a software component that enables machine 1300 to interoperate with control server 108 and client device 112. Machine 1300 may be a standalone device or may be capable of interoperating with only a certain types of servers or user devices. Add-on online module 1462 expands the capacity and capability of machine 1300 to operate in various modes, described above with reference to FIG. 11, including, but not limited to, the online mode, the simulation mode, the trained mode and the delegation mode. In one or more embodiments, add-on online module 1462 is installed as a software suite that enables machine 1300 to interoperate with control server 108 and client device 112.

Add-on online module 1462 may include, among other modules, screen capture module 1466, command process module 1470, and streaming module 1474. Screen capture module 1466 is a software module that captures user interface 1458 displayed on a display device that is part of or is attached to machine 1300. After the images of the screen are captured, streaming module 1474 processes the captured images and sends them to client device 112 via control server 108 in real-time that enables the user to view the information in user interface 1458 without perceivable delay or with only a short delay that does not impede the user's timely control of machine 1300. Command process module 1470 receives commands from client device 112 in the form of the user's input on the user interface captured and sent to client device 112 by screen capture module 1466. Command process module 1470 emulates user actions taken locally on user interface 1458 displayed on a display of machine 1300 when corresponding commands are received from client device 112 located remotely from machine 1300. To interoperate with add-on module 1462, client device may be installed with relevant software.

As a result of its operations, add-on online module 1462 enables control software 1454 to perform various operations on machine 1300 through client device 112. Control software 1454 performs its operations in a manner agnostic to whether the user is controlling machine 1300 remotely via client device 112 or using a display device and input interface 1436 provided locally on machine 1300. By capturing the user interface of control software 1454 and controlling machine 1300 by emulating user input via input interface 1436, complexity associated with different platforms and communication protocols may be obviated or alleviated, facilitating coordinated operations of disparate machines in the facility from a remote location.

Further, when robot 104 is used in conjunction with add-on online module, the user may obtain view the scene of the facility using images captured by robot 104 and operate machine 1300 as if the user was locally present at the facility. That is, the combined use of robot 104 and the add-on online module may further enhance and support the user's teleoperation even when machine 1300 has no camera or only limited functionality to support teleoperation. Hence, the teleoperation capability of machine 1300 may be expanded and the overall remote operation of the facility can be facilitated.

FIG. 15 is an interaction diagram illustrating interactions between machine 1300, robot 104, control server 108 and client device 112, according to one embodiment. Robot 104 captures 1502 images of a scene including machine 1300 and sends 1504 the captured images to control server 108. Control server 108 determines client device 112 to receive the captured images and forwards 1506 the images to client device 112. Instead of control server 108 receiving and forwarding the captured images, robot 104 may directly send the captured images to client device 112 without passing through control server 108. Further, although FIG. 15 illustrates the images of the scene being captured 1502 only a single time followed by sending and forwarding of captured images, robot 104 may continue to capture images of the scene and send the captured scenes to control server 108 and/or client device 112.

Client device 112 receives the captured images of the scene and displays 1507 the images of the captured images. Client device 112 may receive 1508 input from a user through input interface 426 indicating selection of machine 1300 for control or manipulation. The user may select machine 1300 based on the captured images received from robot 104 or based on other reasons such as receiving an alert notification from machine 1300. After receiving the selection, client device 112 sends 1510 a message to control server 108 indicating selection of machine 1300 by the user. In response to receiving the message, control server 108 establishes 1512 communication between client device client device 112 and machine 1300 so that the user may remotely access the user interface of machine 1300 and send commands to machine 1300.

Control software 1454 of machine 1300 generates 1514 the user interface for its operation. Screen capture module 1466 of machine 1300 captures 1518 the generated user interface as images and sends 1520 the captured user interface to control server 108. Control server 108 then forwards 1522 the captured user interface to client device 112. Alternatively, machine 1300 may send the captured images of the user interface directly to client device 112 without passing through control server 108.

The captured images of the user interface are then displayed 1530 by a display of client device 112 via display interface 428. The user may view the displayed images of the user interface at machine 1300 and determine any actions to be taken on the user interface. Then the user enters commands to operate machine 1300 via input interface 426 of client device 112. If no action needs to be taken on machine 1300, the subsequent steps are skipped and the process is terminated. The commands may indicate, for example, preforming various user interface operations (e.g., displaying of a different page of information on the user interface and selecting a graphical user interface element on user interface 1458), setting parameters of operations on machine 1300, and starting/stopping of tasks on machine 1300.

After client device 112 receives 1534 the command to operate machine 1300 from the user, client device 112 sends 1538 the command to control server 108. Control server 108 may then forward 1542 the command to machine 1300. Alternatively, client device 112 may send the command directly to machine 1300 without passing it through control server 108.

Command process module 1470 of machine 1300 receives 1546 the command from control server 108 or client device 112. In response, command process module 1470 emulates 1550 a user action corresponding to manipulation of one or more graphical user elements in user interface 1458. For example, if a command received from control server 108 or client device 112 indicates clicking of an icon in user interface 1458, command process module 1470 emulates the user's action of clicking the same icon displayed on the display of machine 1300. As a result, machine 1300 performs tasks as if the user has performed the clicking operation on the icon displayed on the display.

The steps and their sequence illustrated in FIG. 15 are merely illustrative and various changes may be made to the interactions described in FIG. 15. For example, the process of capturing 1502 images of the scene by robot 104 and generating the user interface 1514 by machine 1300 may be reversed in order or be performed simultaneously.

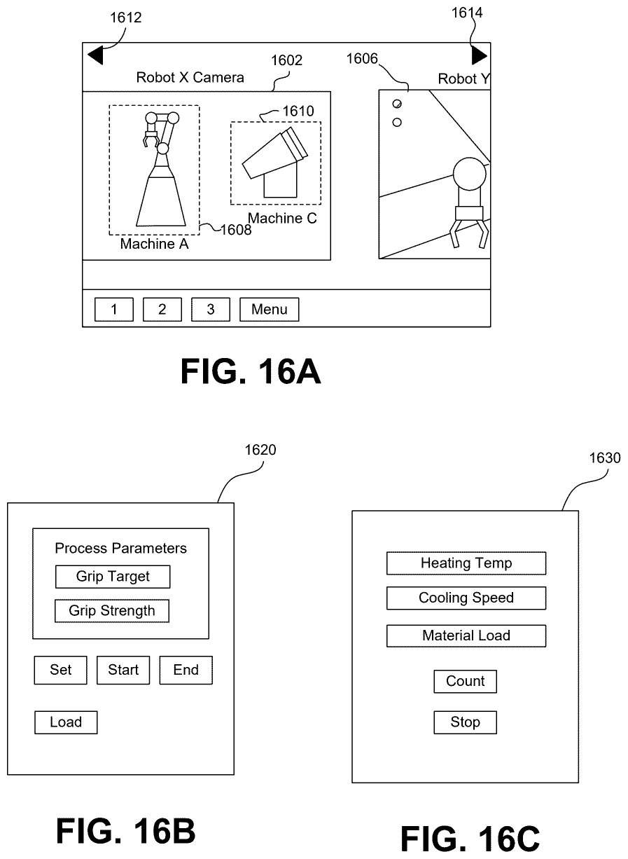

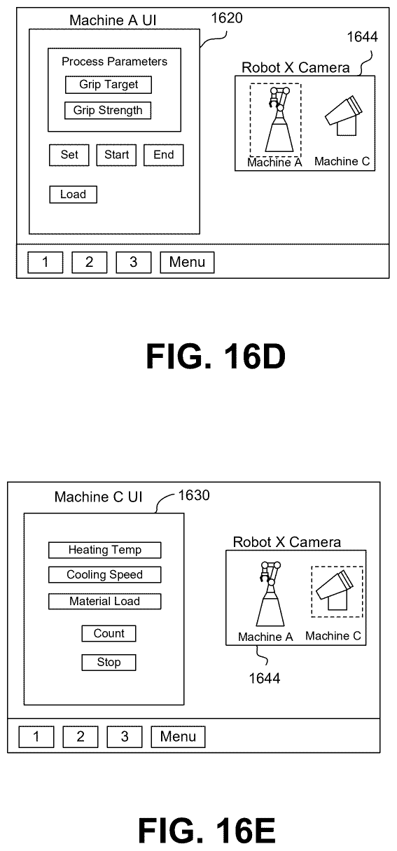

FIG. 16A is a graphical user interface diagram showing scenes captured by cameras, according to one embodiment. The graphical user interface diagram of FIG. 16A includes windows 1602, 1606. Other windows may become visible by selecting arrow 1612 or arrow 1614. Window 1602 displays a scene captured by a camera of robot X while window 1606 displays another scene captured by a camera of robot Y. Although only two windows are displayed in the example of FIG. 16A, more windows may be displayed in a tile or cascaded format. The user may select a machine or robot to operate or control using windows 1602, 1606.

Taking the example of window 1602, the scene of window 1602 includes two machines, machine A and machine C. The identities of the machines may have been detected based on the positions of these machines or by scanning markers on the machines, as described above with reference to FIGS. 12A and 12B. Each of the machines may be selected, for example, by placing a pointer and clicking on a respective region 1608, 1610 in window 1602.

FIGS. 16B and 16C are user interface diagrams of machines A and C, respectively, according to one embodiment. Machine A may be a robot with a gripper, and user interface 1620 of machine A enables the user to select process parameters such as the grip target or grip strength, and other operational commands (e.g., set, start and end). Machine C may be an injection molding machine and its user interface 1630 may display graphical user interface elements that enable setting of heating temperature, cooling speed, and material load speed. The robot of FIG. 16B and the injection molding machine of FIG. 16C are merely examples, and various other machines may be operated using their own user interfaces.

In one or more embodiments, client device 112 switches to display user interface 1620 or user interface 1630 when the user selects a corresponding machine by clicking on region 1608 or 1610 in window 1602. In other embodiments, a part of or the entirety of window 1602 switches to display user interface 1620 or user interface 1630 when the user selects a corresponding machine. After using the user interface 1620 or user interface 1630 to manipulate the corresponding machine, the user may revert back to what is shown in FIG. 16A.

FIG. 16D is a user interface diagram displayed on client device 112 where user interface 1620 of machine A is shown, according to one embodiment. When the user selects machine A in window 1602, window 1602 may zoom out to a smaller window 1644 with machine A being highlighted. On the left side of window 1644, the user interface 1620 of machine A is displayed. The user can take actions on the graphical user interface elements (e.g., icons) of displayed user interface 1620 to take various actions on machine A.

While the user views and interacts with the graphical user interface elements in displayed user interface 1620, window 1644 continues to display the scene as captured by the camera of robot 104, allowing the user to observe the result of the interaction in real time. In this way, the user may perceive the result of the actions taken on user interface 1620 and take further actions in real time, as needed.

On the other hand, FIG. 16E is a user interface diagram showing user interface 1630 of machine C, according to one embodiment. When the user selects machine C in window 1602, window 1602 may zoom out to a smaller window 1644 with machine C being highlighted. On the left side of window 1644, user interface 1630 is displayed. As in the example of FIG. 16D, the user may view and take actions on the graphical user interface elements of window 1646 while window 1644 continues to show the scene in real time.

In one or more embodiments, a training mode of selected machine (e.g., machine A or machine C) may be activated to train the selected machine using the machine learning models or recording of the commands in a controller of the selected machine, control server 108, or client device 112 or any combination thereof. For example, the user interface feedback through displayed user interfaces 1620, 1630, sometime in combination the captured scene in window 1644, may be used as training data to generate the machine learning models or recorded commands that may be subsequently be used to operate the selected machine in a trained mode.

### Alternative Embodiments

In one or more embodiments, the operations and functions performed on the robot, the control server and the client devices are distributed in various manners. For example, if the robot has an onboard computing device with sufficient memory and computing capability, the onboard computing device may run a simulation engine instead of the control server. Conversely, if the onboard computing device has reduced capability, components such as the map manager module and the autonomous navigation module may be removed from the onboard computing device and installed onto the control server and/or the client devices.

Upon reading this disclosure, those of skill in the art will appreciate still additional alternative designs for the robotic system. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method of operating a robot, comprising:
in an online mode:
receiving manual operating commands from a client device in a streaming manner;
sending the received manual operating commands to the robot;
placing the robot in an autonomous navigation mode in which the robot autonomously navigates from a current location of the robot to a destination responsive to receiving a first mode switch command from the client device;
in the autonomous navigation mode:
sending, to the client device, options for selecting the destination to be presented using a map or identifiers displayed on the client device, responsive to receiving the first mode command;
receiving selection of the destination from the client device responsive to sending the options for selecting the destination to the client device; and
causing the robot to autonomously navigate from the current location to the selected destination responsive to receiving the selection of the destination.

2. The method of claim 1, wherein the map comprises a two-dimensional (2D) floorplan or a 2D map, wherein the destination is one of predesignated locations on the map, and wherein the identifiers are mapped to one of the predesignated locations.

3. The method of claim 2, further comprising sending, to the client device, the mapping of the identifiers to the predesignated locations for presentation on the client device.

4. The method of claim 1, further comprising:
switching to a simulation mode responsive to receiving a second mode switch command from the client device;
in the simulation mode:
causing the client device to display a simulated environment corresponding to a real environment of the robot;
receiving simulation commands from the client device to perform simulation of performing a task using the robot;
simulating interaction between a virtual version of the robot and one or more virtual objects in the simulated environment that correspond to one or more real objects in the real environment in response to the received simulation commands to generate a simulated result; and
sending the simulated result to the client device to display the interaction between the robot and the one or more virtual objects.

5. The method of claim 4, further comprising removing a virtual version of a part of the robot or a virtual version of another object occluding the one or more virtual objects from displaying at the client device.

6. The method of claim 4, further comprising, in the simulation mode:
generating a machine learning model or recording corresponding to the task and derived from the simulation commands; and
sending the machine learning model or the recording to the robot for deployment.

7. The method of claim 6, further comprising:
switching to a trained mode responsive to receiving a third mode switch command from the client device;
in the trained mode:
receiving, from the client device, a task command to perform the task by the robot; and
causing the robot to load and execute the machine learning model or the recording.

8. The method of claim 1, further comprising:
switching to a delegation mode responsive to receiving a second mode switch command from the client device;
in the delegation mode:
receiving a delegation command from the client device indicating delegation of control of at least part of the robot to another person;
response to receiving the delegation command, receiving delegated commands from the other person; and
response to receiving the delegated commands from the other person, sending the delegated commands to the robot to control the robot.

9. The method of claim 8, further comprising:
sending options for selecting the other person to the client device for presenting on the client device, the delegation command received responsive to sending the operations for selecting the other person to the client device; and
causing the options for selecting the other person to be displayed on the client device.

10. The method of claim 1, further comprising:
receiving a transition command from the client device to transition from control of the robot to another robot responsive to sending, to the client device, choices of robots available for transitioning;
sending operating commands received from the client device to the other robot responsive to receiving the transition command; and
forwarding information received from the other robot to the client device responsive to receiving the transition command.

11. The method of claim 1, wherein at least part of the manual operating commands in the online mode are sent to another robot by the robot to control the other robot.

12. The method of claim 11, further comprising receiving a sensor signal from the other robot via the robot.

13. The method of claim 1, further comprising:
receiving captured versions of images representing a user interface for operating a machine;
sending the captured versions of the images to the client device to cause the client device to display the captured versions of the images on the client device;
receiving a command from the client device responsive to sending the captured versions of the images to the client device, the command indicating manipulation associated with one or more graphical user elements in the user interface; and
sending the command to the machine to cause the machine to emulate a user action corresponding to the command on the one or more graphical user elements.

14. A method of operating a robot, comprising:
displaying, by a client device, first graphical user interface elements corresponding to locations available for selection as a destination of the robot using a map or identifiers of the locations;
receiving selection of the destination among the available locations by selecting one of the first graphical user interface elements responsive to displaying the graphical user interface elements; and
sending the destination to the robot responsive to receiving the selection of the destination to cause the robot to autonomously navigate to the destination.

15. The method of claim 14, wherein the map comprises a two-dimensional (2D) floorplan or a 2D map, wherein the destination is one of predesignated locations on the map, and wherein the identifiers are mapped to one of the predesignated locations.

16. The method of claim 15, further comprising receiving mapping of the identifiers to the predesignated locations from a computing device located remotely from the client device.

17. The method of claim 14, further comprising:
displaying a second graphical user interface element selectable to switch to a simulation mode;
sending a first mode switch command to a computing device responsive to receiving a selection of the displayed second graphical user interface element;
receiving information on simulated environment corresponding to real environment of the robot responding to sending the first mode switch command;
displaying the simulated environment responsive to receiving the information on the simulated environment;
sending simulation commands to the computing device to perform simulation of the robot performing a task;
receiving a simulated result from the computing device responsive to sending the simulation commands, the simulated result generated by simulating interaction between a virtual version of the robot and one or more virtual objects in the simulated environment that corresponds to one or more real objects in the real environment; and
displaying the simulated result.

18. The method of claim 17, wherein the simulated environment is displayed as one or more of a virtual reality (VR), a mixed reality (MR) or an augmented reality (AR).

19. The method of claim 17, further comprising removing a virtual version of a part of the robot or a virtual version of another object occluding the one or more virtual objects from the simulated environment.

20. The method of claim 17, further comprising:
displaying a third graphical user interface element selectable to switch to a trained mode;
sending a second mode switch command to the computing device to cause the robot to switch to the trained mode, responsive to receiving selection of the displayed third graphical user interface element; and
sending a task command to perform a trained task by causing the robot to load and execute a machine learning model or a recording associated with the trained task.

21. The method of claim 14, further comprising:
displaying a second graphical user interface element; and
sending a delegation command to a computing device communicating with the robot responsive to selection of the second graphical user interface element, the delegation command indicating delegation of control of at least part of the robot from an operator to another person.

22. The method of claim 21, further comprising displaying third graphical user interface elements for selecting the other person.

23. The method of claim 14, further comprising:
displaying a second graphical user interface element corresponding to another robot;
sending a transition command to a computing device communicating with the robot, responsive to receiving selection of the second graphical user interface element;
sending operating commands to control the other robot responsive to sending the transition command; and
receiving an operating status of the other robot responsive to sending the transition command.

24. A method of remotely managing a facility, comprising:
receiving captured versions of images representing a user interface for operating a machine in the facility, the user interface generated by the machine;
sending the captured versions of the images to a client device to cause the client device to display the captured versions of the images on the client device;
receiving a command from the client device responsive to sending the captured versions of the images to the client device, the command indicating manipulation of one or more graphical user elements in the user interface; and
sending the command to the machine to cause the machine to emulate a user action corresponding to the command on the one or more graphical user elements.

25. The method of claim 24, further comprising:
receiving images of a scene including the machine from a camera; and
sending the images of the scene to the client device to cause the client device to display the images of the scene.

26. The method of claim 24, further comprising:
receiving selection of the machine from the client device, the facility comprising a plurality of machine including the machine, the captured versions of images sent to the client device responsive to receiving the selection of the machine.

27. The method of claim 24, further comprising:
training a machine learning model using the command or recording the command for a subsequent operation of the machine.
